(19) United States
(12) Patent Application Publication
(10) Pub. No.: US 2026/0283260 A1
(43) Pub. Date: Sep. 24, 2026

(54) AEROSOL-GENERATING DEVICE AND METHOD OF HEATING AN AEROSOL-FORMING SUBSTRATE TO GENERATE AN AEROSOL

(71) Applicant: Philip Morris Products S.A., Neuchatel (CH)

(72) Inventors: Oleg MIRONOV, Cudrefin (CH); Johannes Petrus Maria PIJNENBURG, Neuchâtel (CH); Enrico STURA, Palézieux-Village (CH)

(73) Assignee: Philip Morris Products S.A., Neuchatel (CH)

(21) Appl. No.: 19/478,867

(22) PCT Filed: Apr. 25, 2024
(86) PCT No.: PCT/EP2024/061438

§ 371 Date: Oct. 27, 2025

(30) Foreign Application Priority Data
May 2, 2023 (EP) 23171154.0

(51) Int. Cl. A24F 40/57; A24F 40/20; A24F 40/465; A24F 40/53

(52) U.S. Cl. CPC A24F 40/57; A24F 40/465; A24F 40/53; A24F 40/20

(57) ABSTRACT

An aerosol-generating device is provided, including: a controller; power circuitry to generate first and second waveforms of electric power independently controllable of each other; and a heating assembly to heat a removable aerosol-forming substrate enclosing or containing a susceptor to generate aerosol from the substrate, the assembly including an inductor coil, the controller configured to independently control application of the waveforms to the inductor coil separately or simultaneously to generate heat through one or a combination of: i) resistance heating by the inductor coil to externally heat the substrate, and ii) heating of the susceptor through inductive coupling of the inductor coil with the susceptor to internally heat the substrate, the resistance heating alone corresponds to a maintenance heating mode, the heating through inductive coupling alone or with the resistance heating corresponds to a boost heating mode, and the controller being further configured to switch between the modes.

The present disclosure relates to an aerosol-generating device and a method of heating an aerosol-forming substrate to generate an aerosol therefrom.

It is known to evolve an aerosol from an aerosol-forming substrate of an aerosol-generating article by the application of heat to the substrate, so as to avoid burning or combustion of the substrate. It is known to externally apply heat to such an aerosol-generating article to heat the aerosol-forming substrate of the article. Typically, the aerosol-generating article includes a wrapper circumferentially enclosing the aerosol-forming substrate. The wrapper may impede the transfer of heat from outside of the aerosol-generating article to the aerosol-forming substrate, which can result in insufficient heating of the substrate and a poor user experience. Although additional heat can be applied to overcome the effect of the wrapper in impeding heat flow, the aerosol-forming substrate may be heated in a non-uniform manner. More specifically, the heating of the aerosol-forming substrate will be greatest at or adjacent to the wrapper and reduce with increasing distance away from the wrapper into the substrate. It is also known to heat the aerosol-forming substrate of such an article from within the substrate, by use of a heating element located within the interior of the aerosol-forming substrate. Internally heating the aerosol-forming substrate can avoid heat having to traverse through the wrapper to reach the aerosol-forming substrate. However, internally heating the aerosol-forming substrate may still result in the aerosol-forming substrate being heated in a non-uniform manner, with heating of the substrate being greatest at or adjacent to the internal heating element and reducing with increasing distance away from the internal heating element into the substrate. Non-uniform heating of the aerosol-forming substrate can result in the substrate being only partially depleted at the completion of a usage session. Increasing the level of heat applied to the substrate in order to fully deplete the aerosol-forming substrate when using either external heating or internal heating of the substrate may result in unintended and undesired burning of the substrate.

It is therefore desired to heat an aerosol-forming substrate so as to provide for improved depletion of the aerosol-forming substrate, without burning or combustion of the substrate.

According to a first aspect of the present disclosure, there is provided an aerosol-generating device comprising a controller, power circuitry, and a heating assembly for heating a removable aerosol-forming substrate enclosing or containing a susceptor to generate an aerosol from the aerosol-forming substrate. The power circuitry may be configured to generate first and second waveforms of electric power that are independently controllable of each other. The heating assembly may comprise an inductor coil. The controller may be configured to independently control application of the first and second waveforms to the inductor coil separately or simultaneously with each other to generate heat through one or a combination of: i) resistance heating by the inductor coil, for externally heating the aerosol-forming substrate, and ii) heating of the susceptor through inductive coupling of the inductor coil with the susceptor, for internally heating the aerosol-forming substrate.

The controller may modulate the power circuitry in order to control the application of one or both of the first and second waveforms to the inductor coil.

The heating assembly may include a coil configured to act as both the inductor coil and a resistive heating element. Independently controlling application of the first and second waveforms to the inductor coil separately or simultaneously with each other provides greater flexibility in the application of heat to the aerosol-forming substrate by the heating assembly. By way of example, the independent control may allow for changing a level of resistance heating by the inductor coil, or changing a level of heating of the susceptor through inductive coupling of the inductor coil with the susceptor, or a combination thereof. The controller may be configured to trigger such a change based on one or more of a) a puff being applied (or ceasing to be applied) to the aerosol-forming substrate (or to an aerosol-generating article of which the substrate forms part), b) a cumulative time elapsed over a usage session or a cumulative time of a portion of a usage session, c) a volume of aerosol generated from the aerosol-forming substrate in response to an individual puff or cumulatively after a series of puffs in a usage session attaining or exceeding a predetermined value, and d) a user manually depressing a button or engaging with some other user interface, such as a touch sensitive interface of the aerosol-generating device.

The power circuitry may take various forms and include one or more current sources, one or more voltage sources, or a combination thereof. The current or voltage sources may include one or more AC sources, one or more DC sources, or a combination thereof. The following paragraphs describe some exemplary configurations for the power circuitry.

The power circuitry may comprise a first current source and a second current source. The first current source and the second current source may be connected to the inductor coil for applying two superposed currents as the first and second waveforms, respectively, to the inductor coil. The first and second current sources may be arranged to be in parallel with each other.

The power circuitry may comprise a first voltage source and a second voltage source. The first voltage source and the second voltage source may be connected in series with each other for applying two superposed voltages as the first and second waveforms, respectively, to the inductor coil.

The power circuitry may comprise a single voltage source or single current source controllable to provide both the first and second waveforms of electric power for application to the inductor coil.

In general terms, inductive coupling between the inductor coil and the susceptor will vary with changes in frequency of alternating current or voltage applied to the inductor coil. The frequency of an alternating current or voltage applied to the inductor coil may be adjusted to have a value f_{susceptor}, associated with the alternating current or voltage creating a varying magnetic field that best or sufficiently couples with the susceptor so as to allow transfer of almost the totality of the dissipated energy in the alternating current or voltage to the susceptor, by eddy or Foucault's currents and/or magnetic hysteresis losses in the susceptor. In turn, this results in most of the heat arising from the applied alternating current or voltage being generated by heating of the susceptor. The frequency may also be adjusted to have a value f_{inductor coil}, associated with the alternating current or voltage creating a magnetic field that provides little or no coupling with the susceptor and allows almost the totality of the dissipated energy in the alternating current or voltage to remain within the inductor coil, by Joule or resistance heating in the coil. In turn, this results in most of the heat arising from the applied alternating current or voltage being generated by resistance heating of the inductor coil. The frequency may also be adjusted to have a value fₜₒₜₐₗ, associated with the alternating current or voltage providing a combination of heating of the susceptor (through inductive coupling of the inductor coil with the susceptor) and resistance heating of the inductor coil. Each of these frequencies will vary depending on the materials, physical properties and configuration of the inductor coil and susceptor, such as the inductance of the inductor coil and magnetic permeability of the material(s) employed for the susceptor.

One of the first and second waveforms of electric power may be optimised to provide resistance heating by the inductor coil. The other of the first and second waveforms of electric power may be optimised for inductively coupling the inductor coil to the susceptor to thereby heat the susceptor. The optimisation of the first and second waveforms may be achieved through modulation of the power circuitry by the controller.

Preferably, the controller is configured to modulate the power circuitry such that the (i) resistance heating is performed by applying one or more of: a) an alternating current or voltage as the first waveform of electric power to the inductor coil at a frequency for inhibiting inductive coupling with the susceptor; and b) a direct current or voltage as the first waveform of electric power to the inductor coil. Whilst the application of alternating current or voltage to the inductor coil is likely to result in some level of inductive coupling with the susceptor, the level of inductive coupling will vary depending on the frequency of the applied alternating current or voltage. Where the frequency of the applied alternating current or voltage inhibits inductive coupling with the susceptor, it will be understood that most (for example, at least 80%, at least 85%, at least 90% or at least 95%) or all of the dissipated energy in the alternating current or voltage will remain in the inductor coil, resulting in resistance heating of the inductor coil in preference to heating of the susceptor. The application of a direct current to the inductor coil will not generate an alternating magnetic field and therefore will not result in inductive coupling with and heating of the susceptor, with the heating effect of the direct current instead being confined to resistance heating of the inductor coil.

Preferably, the controller is configured to modulate the power circuitry such that the (ii) heating of the susceptor is performed by applying an alternating current or voltage as the second waveform of electric power to the inductor coil at a frequency for promoting inductive coupling with the susceptor. Where the frequency of the applied alternating current or voltage promotes inductive coupling with the susceptor, it will be understood that most (for example, at least 80%, at least 85%, at least 90%, or at least 95%) or all of the dissipated energy in the alternating current or voltage will be conveyed to the susceptor via inductive coupling between the inductor coil and the susceptor, resulting in heating of the susceptor in preference to heating of the inductor coil. The heating of the susceptor may occur through one or both of eddy current heating and magnetic hysteresis losses.

Preferably, the controller is configured to control the application of the first and second waveforms to the inductor coil by modulating the power circuitry to operate the heating assembly in each of a first heating mode and a second heating mode. For the first heating mode, a temperature inside a heating zone heated by the heating assembly is below a vaporisation or aerosolisation temperature of an aerosol-forming material of the aerosol-forming substrate. For the second heating mode, a temperature inside the heating zone heated by the heating assembly is at or above the vaporisation or aerosolisation temperature. The first heating mode may be referred to as a maintenance heating mode. The second heating mode may be referred to as a boost heating mode or aerosol-generating mode.

Advantageously, the controller is configured to control the application of the first and second waveforms to the inductor coil by modulating the power circuitry to adjust a ratio of a power dissipated by resistance heating of the inductor coil to a power dissipated by heating of the susceptor through inductive coupling of the inductor coil with the susceptor from a first ratio for the first heating mode to a second ratio for the second heating mode. In this manner, heat may be supplied to the aerosol-forming substrate according to the following heating regimes: a) solely or predominantly through the resistance heating of the inductor coil; b) solely or predominantly through heating of the susceptor through the inductive coupling of the inductor coil with the susceptor; c) a combination of resistance heating of the inductor coil, and heating of the susceptor through the inductive coupling of the inductor coil with the susceptor. Adjusting the balance of heat generated through resistance heating of the inductor coil relative to heat generated through inductive coupling of the inductor coil with the susceptor may facilitate more uniform heating of the aerosol-forming substrate over a usage session and provide for improved depletion of the aerosol-forming substrate.

Advantageously, the controller may be configured to control the application of the first and second waveforms to the inductor coil by modulating the power circuitry to operate the heating assembly in a third heating mode, in which the heating assembly generates heat through a combination of resistance heating of the inductor coil and heating of the susceptor through inductive coupling of the inductor coil with the susceptor. In this third heating mode, the cumulative energy dissipated by the heating assembly may be greater than for either of the first and second heating modes. This third heating mode may be employed on activation of the aerosol-generating device in order to rapidly heat up the aerosol-forming substrate ready for a user to apply a first puff; the third heating mode may form a preliminary heating mode that is activated before either of the first and second heating modes.

The change between the first and second heating modes- or between any of the first, second and third heating modes—may be achieved in various different ways, as described in the following paragraphs.

The controller may be configured to apply or adjust a frequency of an alternating current or voltage to the inductor coil when switching between the first and second heating modes so as to change the inductive coupling of the inductor coil with the susceptor. The alternating current or voltage to which the frequency relates may form one or both of the first and second waveforms of electric power. By changing the inductive coupling of the inductor coil with the susceptor, the balance of heat generated through resistance heating of the inductor coil relative to heat generated by the susceptor through inductive coupling of the inductor coil with the susceptor may be adjusted.

The controller may be configured to adjust an amplitude of an alternating current or voltage to the inductor coil when switching between the first and second heating modes such that the amplitude differs for the second heating mode relative to the first heating mode. The alternating current or voltage to which the amplitude relates may form one or both of the first and second waveforms of electric power. By increasing or decreasing the amplitude of the alternating current or voltage, more or less power may be provided to the inductor coil. Where the frequency of the alternating current or voltage applied to the inductor coil remains unchanged between the first and second heating modes, the effect of an increase in amplitude will be to increase the level of heating of the inductor coil and/or the susceptor, rather than to change the balance of heat generated through resistance heating of the inductor coil relative to heat generated by the susceptor through inductive coupling of the inductor coil with the susceptor. Changing the amplitude of the alternating current or voltage applied to the inductor coil whilst keeping all other parameters of the alternating current or voltage unchanged acts like a gain control.

The controller may be configured to adjust an amplitude of a direct current or voltage to the inductor coil when switching between the first and second heating modes such that the amplitude differs for the second heating mode relative to the first heating mode. The direct current or voltage to which the amplitude relates may form one or both of the first and second waveforms of electric power. By changing the amplitude of the direct current or voltage, the level of resistance heating of the inductor coil is changed between first and second heating modes. Changing the amplitude of the direct current or voltage whilst keeping all other parameters of the direct current or voltage unchanged acts like a gain control.

The controller may be configured to simultaneously apply both an alternating current or voltage and a direct current or voltage to the inductor coil for one or both of the first and second heating modes. The alternating current or voltage may form one of the first and second waveforms of electric power and the direct current or voltage may form the other of the first and second waveforms of electric power.

The controller may be configured to simultaneously apply both a first alternating current or voltage as the first waveform of electric power and a second alternating current or voltage as the second waveform of electric power to the inductor coil for one or both of the first and second heating modes. One of the first and second alternating currents or voltages may provide a greater degree of inductive coupling than the other of the first and second alternating currents or voltages. In this manner, the first and second waveforms of electric power may provide different levels of heating of the susceptor through inductive coupling of the inductor coil with the susceptor.

The controller may be configured to apply only an alternating current or voltage as one of the first and second waveforms to the inductor coil for one of the first and second heating modes. The controller may also be configured to apply only a direct current or voltage as the other of the first and second waveforms to the inductor coil for the other of the first and second heating modes.

The controller may be configured to modulate the power circuitry to apply an alternating current or voltage to the inductor coil for both of the first and second heating modes. The controller may also be configured to adjust a frequency of the alternating current or voltage applied to the inductor coil when switching between the first and second heating modes so as to change the inductive coupling of the inductor coil with the susceptor. The alternating current or voltage may form one or both of the first and second waveforms of electric power.

Advantageously, where the controller is configured to modulate the power circuitry to apply an alternating current or voltage to the inductor coil for both of the first and second heating modes, the controller may be configured to adjust the frequency of the alternating current or voltage applied to the inductor coil when switching between the first and second heating modes so as to increase the inductive coupling of the inductor coil with the susceptor. In this manner, the level of heating provided by the susceptor may be increased.

Where the controller is configured to modulate the power circuitry to apply an alternating current or voltage to the inductor coil for both of the first and second heating modes, the controller may be configured to adjust the frequency of the alternating current or voltage applied to the inductor coil from a first value or range of values for the first heating mode to a second value or range of values for the second heating mode. The second frequency value or range of values may be closer than the first frequency value or range of values to a resonant frequency of the heating assembly. In this manner, the level of heating provided by the susceptor may be increased for the second heating mode over that for the first heating mode. The resonant frequency may be determined according to the following equation:

$${f}_{R} = \frac{1}{2 π \sqrt{L C}}$$

in which f_{R} is the resonant frequency, L is an inductance of the heating assembly and C is a capacitance of the heating assembly. The resonant frequency is associated with maximising the responsiveness of the heating assembly to an applied voltage or current.

Where the controller is configured to modulate the power circuitry to apply an alternating current or voltage to the inductor coil for both of the first and second heating modes, the controller may be configured to apply only the alternating current or voltage to the inductor coil for the first heating mode. The alternating current or voltage may form one or both of the first and second waveforms of electric power.

Where the controller is configured to modulate the power circuitry to apply an alternating current or voltage to the inductor coil for both of the first and second heating modes, the controller may be configured to apply a direct current or voltage to the inductor coil in addition to the alternating current for one or both of the first and second heating modes. The direct current or voltage may form one or both of the first and second waveforms of electric power. The controller may be configured to pause the application of the direct current or voltage to the inductor coil on switching to the second heating mode.

The controller may be configured to modulate the power circuitry to apply a direct current or voltage to the inductor coil for the first heating mode; and on switching to the second heating mode, introduce an alternating current or voltage to the inductor coil. A frequency of the alternating current or voltage may be controlled such that all, a majority, or a substantial part of the thermal power dissipated by the heating assembly in response to the supply of alternating current or voltage arises from heating of the susceptor rather than heating of the inductor coil. The direct current or voltage may form one of the first and second waveforms of electric power and the alternating current or voltage may form the other of the first and second waveforms of electric power. The controller may be configured to pause the application of the direct current or voltage to the inductor coil on switching to the second heating mode. Alternatively, the controller may be configured to maintain the application of the direct current or voltage to the inductor coil over both the first and second heating modes.

The controller may be configured to modulate the power circuitry to apply one of first and second alternating currents or voltages to the inductor coil for the first heating mode; and apply the first and second alternating currents or voltages superposed with each other to the inductor coil for the second heating mode. The first alternating current or voltage may form one of the first and second waveforms of electric power and the second alternating current or voltage may form the other of the first and second waveforms of electric power.

The controller may be configured to modulate the power circuitry to apply one of first and second direct currents or voltages to the inductor coil for the first heating mode; and apply the first and second direct currents or voltages superposed with each other to the inductor coil for the second heating mode. The first direct current or voltage may form one of the first and second waveforms of electric power and the second direct current or voltage may form the other of the first and second waveforms of electric power.

The switching between the first and second heating modes or the application of different ones of the first and second waveforms of electric power to the inductor coil may be triggered in various different ways. The trigger may be the controller receiving a signal indicative of a puff being applied to the aerosol-forming substrate or to an aerosol-generating article of which the substrate forms part. Detection of the application (or cessation) of a puff may be achieved by use of an airflow sensor, a pressure sensor, or a temperature sensor as part of the aerosol-generating device. The heating assembly may itself or in combination with the susceptor function as a means of determining temperature, or of detecting or determining changes in temperature. Alternatively, the trigger may be a user manually depressing a button or engaging with some other user interface, such as a touch sensitive interface of the aerosol-generating device, the button or other touch sensitive interface being coupled to the controller.

Preferably, the controller is configured to switch between the first and second heating modes in response to receiving a signal indicative of an applied puff. In one example, the controller may be configured to apply one of the first and second waveforms to the inductor coil in the first heating mode prior to receiving (or in the absence of) a signal indicative of an applied puff, and switch to applying the other of the first and second waveforms in the second heating mode in response to receiving the signal indicative of an applied puff. In another example, the controller may be configured to apply one of the first and second waveforms of electric power to the inductor coil in the first heating mode prior to receiving (or in the absence of) a signal indicative of an applied puff, and switch to applying both of the first and second waveforms of electric power in the second heating mode in response to receiving the signal indicative of an applied puff.

The controller may be configured, in response to receiving the signal indicative of the applied puff, to reduce or deactivate resistance heating by the inductor coil and increase or activate heating of the susceptor through inductive coupling of the inductor coil with the susceptor.

The controller may be configured to determine a starting point and an end point of the applied puff and maintain the heating assembly in the second heating mode over the duration of the applied puff. The controller may also be configured to switch from the second heating mode back to the first heating mode upon determination of the end point of the applied puff. Detection of the starting point and end point of an applied puff may be achieved by use of a pressure sensor or a temperature sensor as part of the aerosol-generating device. The heating assembly may itself or in combination with the susceptor function as a means of determining temperature, or of detecting or determining changes in temperature.

To facilitate the detection of a puff (and/or the starting & end points of a puff), the aerosol-generating device may include one or more of the features set forth in PCT Patent Application Publication Nos. WO2020/216765, WO2022/184776, WO2022/003072, WO2013/098397 and WO2004/043175, the entire contents of each of which are incorporated herein by reference thereto. More specifically, PCT Patent Application Publication No. WO2020/216765 relates to detecting a puff using a temperature sensor to detect a temperature change of air flow in a receiving cavity of an aerosol-generating device indicative of a user taking a puff; PCT Patent Application Publication No. WO2022/184776 relates to detecting a puff using a heat transfer element and a temperature sensor in contact with the heat transfer element; PCT Patent Application Publication Nos. WO2022/003072 and WO2013/098397 relate to detecting a puff based on monitoring changes in power supplied to a heating element used for the generation of aerosol, and PCT Patent Application Publication No. WO2004/043175 relates to puff detection using a manifold.

Preferably, the controller is configured to control a supply of electric energy to the inductor coil so as to maintain a temperature of the inductor coil at a target temperature or to follow a target temperature profile. Alternatively or in addition, the controller may be configured to control the supply of electric energy to the inductor coil so as to maintain a temperature of the susceptor at a target temperature or to follow a target temperature profile. The target temperature or target temperature profile may be stored in a memory module communicatively coupled to or integrated with the controller. The target temperature profile may comprise a first target temperature profile corresponding to no puff being applied, and a second target temperature profile corresponding to application of an applied puff. The first target temperature profile may be associated with the first heating mode and the second target temperature profile associated with the second heating mode.

Preferably, the aerosol-generating device comprises the susceptor. The aerosol-generating device may comprise a chamber, the inductor coil surrounding or at least partially defining a peripheral wall of the chamber, the susceptor arranged within the chamber. The chamber may be configured to receive an aerosol-generating article comprising the aerosol-forming substrate such that the susceptor extends within the aerosol-generating article. The susceptor may extend from a base of the chamber along a longitudinal axis of the chamber. The susceptor may be formed as a pin or blade. Having the susceptor extending within the aerosol-forming substrate facilitates internally heating the aerosol-forming substrate during use of the aerosol-generating device, with the level of internal heating depending on the degree of inductive coupling between the inductor coil and susceptor. In contrast, the inductor coil permits externally heating the aerosol-forming substrate of the aerosol-generating article. The inductor coil may be arranged to be in surface contact with an exterior surface of the aerosol-generating article, thereby facilitating conduction of heat from the inductor coil to the aerosol-generating article.

As an alternative to the susceptor forming part of the aerosol-generating device, the susceptor may instead form part of an aerosol-generating article, for example a removable and disposable aerosol-generating article. More specifically, an aerosol-generating system may be provided comprising an aerosol-generating device, the aerosol-generating system further comprising an aerosol-generating article, the aerosol-generating article comprising the aerosol-forming substrate and the susceptor. The susceptor may be enclosed by or at least partially embedded within the aerosol-forming substrate. The aerosol-generating device may comprise a chamber, the inductor coil surrounding or at least partially defining a peripheral wall of the chamber. The chamber may be configured to receive the aerosol-generating article such that the susceptor is positioned at least partially within the inductor coil. Having the susceptor enclosed by or at least partially embedded within the aerosol-forming substrate facilitates internally heating the aerosol-forming substrate during use of the aerosol-generating device, with the level of internal heating depending on the degree of inductive coupling between the inductor coil and susceptor. In contrast, the inductor coil allows for externally heating the aerosol-forming substrate of the aerosol-generating article. The inductor coil may be arranged to be in surface contact with an exterior surface of the aerosol-generating article, thereby facilitating conduction of heat from the inductor coil to the aerosol-generating article.

The inductor coil may be suspended inside the chamber of the aerosol-generating device. This reduces heat losses from the inductor coil to a housing of the aerosol-generating device in which the chamber is defined and so improves the thermal efficiency of the device. The inductor coil may be a helical coil. The helical coil may comprise a first end and a second end. The housing may contact the inductor coil only at the first end and the second end of the inductor coil.

The inductor coil may comprise a flat spiral inductor coil. The inductor coil may have a tubular shape or a helical shape. Preferably, the inductor coil is both tubular and helical. Preferably, the tubular and helical coil has a non-circular cross section, when viewed in a direction perpendicular to the longitudinal length direction of the coil, i.e. in a direction perpendicular to the magnetic centre-axis of the coil. Where the inductor coil is intended to be in surface contact with an exterior surface of the aerosol-generating article, the use of a coil having a flat cross-sectional profile may facilitate conduction between the coil and the article of heat generated by resistive heating of the coil.

The inductor coil may be formed from a coiled wire. The coiled wire may comprise an electrically conductive core and a coating on the electrically conductive core. The coating may be electrically insulating. The coating may comprise at least one of a polymer, a ceramic, and a glass.

The inductor coil may comprise a metal. The metal may comprise copper or stainless steel.

Preferably, the power circuitry comprises or is coupled to one or more electric power sources. The one or more electric power sources may comprise any one or more of the first and second current sources, first and second voltage sources, and the single voltage source described above. The power source may comprise a DC power source. The DC power source may be a battery, preferably being a rechargeable battery. The power circuitry may also comprise a DC/AC converter couplable or coupled to the DC power source. It is also possible that there is a DC/DC converter between the electric power source and the DC/AC converter for providing at least one of galvanic separation between the power circuitry and the electric power source, and for applying a different DC voltage level as compared to the output voltage of the electric power source to the DC/AC converter.

The power circuitry is preferably configured to operate at high frequency. The power circuitry may comprise a DC/AC converter connected to a first DC power source, the DC/AC converter including a Class-E power amplifier including a first transistor switch and an LC load network. The LC load network may comprise a shunt capacitor and a series connection of a capacitor and the inductor coil. The power circuitry may also include a choke inductor between the first DC power source and the capacitor.

The power circuitry preferably includes a second DC power source connected to the LC load network at a position between the capacitor and the inductor coil, for supplying DC current to the inductor coil. The second DC power source may be the same power source as the first DC power source, e.g. they may be the same battery. The power circuitry may include a choke inductor between the second DC power source and the capacitor. The choke inductor preferably has a higher inductance value than the inductor coil. The power circuitry may include a second switch between the second DC power source and the inductor coil. The second switch may be a second transistor switch.

The power circuitry may include a second capacitor, the second capacitor connected in parallel with the inductor coil. This may reduce a difference between f_{susceptor} and f_{inductor coil}.

For the purpose of this application, the term “high frequency” is to be understood to denote a frequency ranging from about 1 Megahertz (MHz) to about 30 Megahertz (MHz) (including the range of 1 MHz to 30 MHz), in particular from about 1 Megahertz (MHz) to about 10 MHz (including the range of 1 MHz to 10 MHz), and even more particularly from about 5 Megahertz (MHz) to about 7 Megahertz (MHz) (including the range of 5 MHz to 7 MHz).

Class-E power amplifiers are generally known and are described in detail, for example, in the article “Class-E RF Power Amplifiers”, Nathan O. Sokal, published in the bimonthly magazine QEX, edition January/February 2001, pages 9-20, of the American Radio Relay League (ARRL), Newington, CT, U.S.A. Class-E power amplifiers are advantageous as regards operation at high frequencies, while at the same time having a simple circuit structure comprising a minimum number of components (e.g. only one transistor switch needed, which is advantageous over Class-D power amplifiers which comprise two transistor switches that must be controlled at high frequency in a manner so as to make sure that one of the two transistors has been switched off at the time the other of the two transistors is switched on). In addition, Class-E power amplifiers are known for minimum power dissipation in the switching transistor during the switching transitions. Preferably, the Class-E power amplifier is a single-ended first order Class-E power amplifier having a single transistor switch only.

The transistor switch of the Class-E power amplifier can be any type of transistor and may be embodied as a bipolar-junction transistor (BJT). More preferably, however, the transistor switch is embodied as a field effect transistor (FET) such as a metal-oxide-semiconductor field effect transistor (MOSFET) or a metal-semiconductor field effect transistor (MESFET).

The LC load network of the Class-E power amplifier is preferably configured to operate at low ohmic load. The term “low ohmic load” is to be understood to denote an ohmic load smaller than about 2 Ohms. The LC load network may comprise a shunt capacitor, and a series connection of a capacitor and an inductor having an ohmic resistance. This ohmic resistance of the inductor is typically a few tenths of an Ohm. In operation, the ohmic resistance of the susceptor adds to the ohmic resistance of the inductor coil and should be higher than the ohmic resistance of the inductor coil, since the supplied electrical power should be converted to heat in the susceptor to as high an extent as possible in order to increase efficiency of the power amplifier and to allow transfer of as much heat as possible from the susceptor to the rest of the aerosol-forming substrate to effectively produce the aerosol.

According to a second aspect of the present disclosure, there is provided a method of heating an aerosol-forming substrate to generate an aerosol therefrom. The method may comprise providing a heating assembly comprising an inductor coil and a susceptor, the inductor coil positioned external to the aerosol-forming substrate, the susceptor enclosed within the aerosol-forming substrate, the susceptor positioned at least partially within the inductor coil. The method may further comprise providing power circuitry configured to generate first and second waveforms of electric power that are independently controllable of each other. The method may further comprise independently controlling application of the first and second waveforms to the inductor coil separately or simultaneously with each other to generate heat through one or a combination of: i) resistance heating by the inductor coil, for externally heating the aerosol-forming substrate, and ii) heating of the susceptor through inductive coupling of the inductor coil with the susceptor, for internally heating the aerosol-forming substrate.

Preferably, the (i) resistance heating by the inductor coil comprises applying one or more of: a) an alternating current or voltage as the first waveform of electric power to the inductor coil at a frequency for inhibiting inductive coupling with the susceptor; and b) a direct current or voltage as the first waveform of electric power to the inductor coil. As discussed in preceding paragraphs, whilst the application of alternating current or voltage to the inductor coil is likely to result in some level of inductive coupling with the susceptor, the level of inductive coupling will vary depending on the frequency of the applied alternating current or voltage. Where the frequency of the applied alternating current or voltage inhibits inductive coupling with the susceptor, it will be understood that most (for example, at least 80%, at least 85%, at least 90% or at least 95%) or all of the energy in the alternating current or voltage will remain in the inductor coil, resulting in resistance heating of the inductor coil in preference to heating of the susceptor. The application of a direct current to the inductor coil will not generate an alternating magnetic field and therefore will not result in inductive coupling with and heating of the susceptor, with the heating effect of the direct current instead being confined to resistance heating of the inductor coil.

The (ii) heating of the susceptor through inductive coupling with the susceptor may comprise applying an alternating current or voltage as the second waveform of electric power to the inductor coil at a frequency for promoting inductive coupling with the susceptor. As described in preceding paragraphs, where the frequency of the applied alternating current or voltage promotes inductive coupling with the susceptor, it will be understood that most (for example, at least 80%, at least 85%, at least 90%, or at least 95%) or all of the energy in the alternating current or voltage will be conveyed to the susceptor via inductive coupling between the inductor coil and the susceptor, resulting in heating of the susceptor in preference to heating of the inductor coil. The heating of the susceptor may occur through one or both of eddy current heating and magnetic hysteresis losses.

The method may comprise controlling the application of the first and second waveforms to the inductor coil to operate the heating assembly in each of a first heating mode and a second heating mode. In the first heating mode, a temperature inside a heating zone heated by the heating assembly is below a vaporisation or aerosolisation temperature of an aerosol-forming material of the aerosol-forming substrate. In the second heating mode, a temperature inside the heating zone heated by the heating assembly is at or above the vaporisation or aerosolisation temperature.

The method may comprise controlling the application of the first and second waveforms to the inductor coil to adjust a ratio of a power dissipated by resistance heating of the inductor coil to a power dissipated by heating of the susceptor through inductive coupling of the inductor coil with the susceptor from a first ratio for the first heating mode to a second ratio for the second heating mode. As described in preceding paragraphs, the first heating mode may be referred to as a maintenance heating mode and the second heating mode referred to as a boost heating mode or aerosol-generating mode.

The method may comprise applying or adjusting a frequency of an alternating current or voltage to the inductor coil when switching between the first and second heating modes so as to change the inductive coupling of the inductor coil with the susceptor.

The method may comprise adjusting an amplitude of an alternating current or voltage to the inductor coil when switching between the first and second heating modes such that the amplitude differs for the second heating mode relative to the first heating mode.

The method may comprise adjusting an amplitude of a direct current or voltage to the inductor coil when switching between the first and second heating modes such that the amplitude differs for the second heating mode relative to the first heating mode.

The method may comprise simultaneously applying both an alternating current or voltage and a direct current or voltage to the inductor coil for one or both of the first and second heating modes.

The method may comprise simultaneously applying both a first alternating current or voltage as the first waveform of electric power and a second alternating current or voltage as the second waveform of electric power to the inductor coil for one or both of the first and second heating modes. One of the first and second alternating currents or voltages may provide a greater degree of inductive coupling than the other of the first and second alternating currents or voltages. In this manner, the first and second waveforms of electric power may provide different levels of heating of the susceptor through inductive coupling of the inductor coil with the susceptor.

The method may comprise applying only an alternating current or voltage as one of the first and second waveforms to the inductor coil for one of the first and second heating modes, and applying only a direct current or voltage as the other of the first and second waveforms to the inductor coil for the other of the first and second heating modes

The method may comprise applying an alternating current or voltage to the inductor coil for both of the first and second heating modes; and adjusting a frequency of the alternating current or voltage applied to the inductor coil when switching between the first and second heating modes so as to change the inductive coupling of the inductor coil with the susceptor.

Where an alternating current or voltage is applied to the inductor coil for both of the first and second heating modes, the method may comprise adjusting the frequency of the alternating current or voltage applied to the inductor coil when switching between the first and second heating modes so as to increase the inductive coupling of the inductor coil with the susceptor. In this manner, the level of heating provided by the susceptor may be increased.

Where an alternating current or voltage is applied to the inductor coil for both of the first and second heating modes, the method may comprise adjusting the frequency of the alternating current or voltage applied to the inductor coil from a first value or range of values for the first heating mode to a second value or range of values for the second heating mod. The second frequency value or range of values may be closer than the first frequency value or range of values to a resonant frequency of the heating assembly. In this manner, the level of heating provided by the susceptor may be increased for the second heating mode over that for the first heating mode. The resonant frequency may be determined according to the following equation:

$${f}_{R} = \frac{1}{2 π \sqrt{L C}}$$

in which f_{R} is the resonant frequency, L is an inductance of the heating assembly and C is a capacitance of the heating assembly.

Where an alternating current or voltage is applied to the inductor coil for both of the first and second heating modes, the method may comprise, for the first heating mode, applying only the alternating current or voltage to the inductor coil.

Where an alternating current or voltage is applied to the inductor coil for both of the first and second heating modes, the method may comprise, for one or both of the first and second heating modes, applying a direct current or voltage to the inductor coil in addition to the alternating current. The method may comprise pausing the application of the direct current or voltage to the inductor coil on switching to the second heating mode.

The method may further comprise applying a direct current or voltage to the inductor coil for the first heating mode. On switching to the second heating mode, an alternating current or voltage may be introduced to the inductor coil, a frequency of the alternating current or voltage being controlled such that all, a majority, or a substantial part of the thermal power dissipated by the heating assembly in response to the supply of alternating current or voltage arises from heating of the susceptor rather than heating of the inductor coil. The method may comprise pausing the application of the direct current or voltage to the inductor coil on switching to the second heating mode. Alternatively, the method may comprise maintaining the application of the direct current or voltage to the inductor coil over both the first and second heating modes.

The method may comprise applying one of first and second alternating currents or voltages to the inductor coil for the first heating mode; and applying the first and second alternating currents or voltages superposed with each other to the inductor coil for the second heating mode.

The method may comprise applying one of first and second direct currents or voltages to the inductor coil for the first heating mode; and applying the first and second direct currents or voltages superposed with each other to the inductor coil for the second heating mode.

The method may comprise switching between applying different ones of the first and second waveforms of electric power to the inductor coil in response to receiving a signal indicative of an applied puff.

The method may comprise switching between the first and second heating modes in response to receiving a signal indicative of an applied puff.

The method may comprise, in response to receiving the signal indicative of the applied puff, reducing or deactivating resistance heating by the inductor coil and increasing or activating heating of the susceptor through inductive coupling of the inductor coil with the susceptor.

The method may comprise determining a starting point and an end point of the applied puff and maintaining the heating assembly in the second heating mode over the duration of the applied puff. The method may further comprise switching from the second heating mode back to the first heating mode upon determination of the end point of the applied puff.

The method may comprise controlling a supply of electric energy from the power circuitry to the inductor coil so as to maintain a temperature of the inductor coil at a target temperature or to follow a target temperature profile. Alternatively or in addition, the method may comprise controlling a supply of electric energy from the power circuitry to the inductor coil so as to maintain a temperature of the susceptor at a target temperature or to follow a target temperature profile.

As used herein, the term “aerosol-generating system” is used to describe a plurality of elements configured to provide an interaction with an aerosol-forming substrate to generate an aerosol.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-forming substrate” refers to a substrate consisting of or comprising an aerosol-forming material that is capable of releasing volatile compounds upon heating to generate an aerosol.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

As used herein, the term “aerosol-generating article” refers to an article comprising an aerosol-forming substrate that is capable of releasing volatile compounds that can form an aerosol. An aerosol-generating article may be disposable.

As used herein, the term “usage session” refers to a period in which a series of puffs are applied by a user to extract aerosol from an aerosol-forming substrate.

As used herein, the term “mouthpiece” refers to a portion of an aerosol-generating article, an aerosol-generating device or an aerosol-delivery system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein, the term “inductively couple” refers to the heating of a susceptor when penetrated by an alternating magnetic field. The heating may be caused by the generation of eddy currents in the susceptor. The heating may be caused by magnetic hysteresis losses.

The terms “Joule heating”, “resistance heating” and “resistive heating” are used interchangeably throughout the text and shall be understood to be synonyms of each other.

As used herein, the term “puff” means the action of a user drawing an aerosol into their body through their mouth or nose.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating device may also be referred to as the upstream end. Components, or portions of components, of the aerosol-generating device may be described as being upstream or downstream of one another based on their relative positions with respect to the airflow path of the aerosol-generating device.

As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

The invention is defined in the claims. However, below there is provided a non-exhaustive list of non-limiting examples. Any one or more of the features of these examples may be combined with any one or more features of another example, embodiment, or aspect described herein.
Example Ex1: An aerosol-generating device comprising:
a controller;
power circuitry configured to generate first and second waveforms of electric power that are independently controllable of each other;
a heating assembly for heating a removable aerosol-forming substrate enclosing or containing a susceptor to generate an aerosol from the aerosol-forming substrate, the heating assembly comprising an inductor coil;
wherein the controller is configured to independently control application of the first and second waveforms to the inductor coil separately or simultaneously with each other to generate heat through one or a combination of:
   i) resistance heating by the inductor coil, for externally heating the aerosol-forming substrate, and
   ii) heating of the susceptor through inductive coupling of the inductor coil with the susceptor, for internally heating the aerosol-forming substrate.
Example Ex2: An aerosol-generating device according to Ex1, wherein the power circuitry comprises a first current source and a second current source, the first current source and the second current source connected to the inductor coil for applying two superposed currents as the first and second waveforms, respectively, to the inductor coil.
Example Ex3: An aerosol-generating device according to either one of Ex1 or Ex2, wherein the power circuitry comprises a first voltage source and a second voltage source, the first voltage source and the second voltage source connected in series with each other for applying two superposed voltages as the first and second waveforms, respectively, to the inductor coil.
Example Ex4: An aerosol-generating device according to any one of Ex1 to Ex3, wherein the power circuitry comprises a single voltage source or single current source controllable to provide both the first and second waveforms of electric power for application to the inductor coil.
Example Ex5: An aerosol-generating device according to either any one of Ex1 to Ex4, wherein the controller is configured such that the (i) resistance heating is performed by applying one or more of:
a) an alternating current or voltage as the first waveform of electric power to the inductor coil at a frequency for inhibiting inductive coupling with the susceptor; and
b) a direct current or voltage as the first waveform of electric power to the inductor coil.
Example Ex6: An aerosol-generating device according to any one of Ex1 to Ex5, wherein the controller is configured such that the (ii) heating of the susceptor is performed by applying an alternating current or voltage as the second waveform of electric power to the inductor coil at a frequency for promoting inductive coupling with the susceptor.
Example Ex7: An aerosol-generating device according to any one of Ex1 to Ex6, wherein the controller is configured to control the application of the first and second waveforms to the inductor coil to operate the heating assembly in each of:
a first heating mode in which a temperature inside a heating zone heated by the heating assembly is below a vaporisation or aerosolisation temperature of an aerosol-forming material of the aerosol-forming substrate; and
a second heating mode in which a temperature inside the heating zone heated by the heating assembly is at or above the vaporisation or aerosolisation temperature.
Example Ex8: An aerosol-generating device according to Ex7, wherein the controller is configured to control the application of the first and second waveforms to the inductor coil to adjust a ratio of a power dissipated by resistance heating of the inductor coil to a power dissipated by heating of the susceptor through inductive coupling of the inductor coil with the susceptor from a first ratio for the first heating mode to a second ratio for the second heating mode.
Example Ex9: An aerosol-generating device according to either one of Ex7 or Ex8, wherein the controller is configured to apply or adjust a frequency of an alternating current or voltage to the inductor coil when switching between the first and second heating modes so as to change the inductive coupling of the inductor coil with the susceptor.
Example Ex10: An aerosol-generating device according to any one of Ex7 to Ex9, wherein the controller is configured to adjust an amplitude of an alternating current or voltage to the inductor coil when switching between the first and second heating modes such that the amplitude differs for the second heating mode relative to the first heating mode.
Example Ex11: An aerosol-generating device according to any one of Ex7 to Ex10, wherein the controller is configured to adjust an amplitude of a direct current or voltage to the inductor coil when switching between the first and second heating modes such that the amplitude differs for the second heating mode relative to the first heating mode.
Example Ex12: An aerosol-generating device according to any one of Ex7 to Ex11, wherein the controller is configured to simultaneously apply both an alternating current or voltage and a direct current or voltage to the inductor coil for one or both of the first and second heating modes.
Example Ex13: An aerosol-generating device according to any one of Ex7 to Ex12, wherein the controller is configured to simultaneously apply both a first alternating current or voltage as the first waveform of electric power and a second alternating current or voltage as the second waveform of electric power to the inductor coil for one or both of the first and second heating modes, one of the first and second alternating currents or voltages providing a greater degree of inductive coupling than the other of the first and second alternating currents or voltages.
Example Ex14: An aerosol-generating device according to any one of Ex7 to Ex12, wherein the controller is configured to:
apply only an alternating current or voltage as one of the first and second waveforms to the inductor coil for one of the first and second heating modes, and
apply only a direct current or voltage as the other of the first and second waveforms to the inductor coil for the other of the first and second heating modes.
Example Ex15: An aerosol-generating device according to any one of Ex7 to Ex13, wherein the controller is configured to:
apply an alternating current or voltage to the inductor coil for both of the first and second heating modes; and
adjust a frequency of the alternating current or voltage applied to the inductor coil when switching between the first and second heating modes so as to change the inductive coupling of the inductor coil with the susceptor.
Example Ex16: An aerosol-generating device according to Ex15, wherein the controller is configured to adjust the frequency of the alternating current or voltage applied to the inductor coil when switching between the first and second heating modes so as to increase the inductive coupling of the inductor coil with the susceptor.
Example Ex17: An aerosol-generating device according to either one of Ex15 or Ex16, wherein the controller is configured to adjust the frequency of the alternating current or voltage applied to the inductor coil from a first value or range of values for the first heating mode to a second value or range of values for the second heating mode, wherein the second frequency value or range of values is closer than the first frequency value or range of values to a resonant frequency of the heating assembly.
Example Ex18: An aerosol-generating device according to Ex17, wherein the resonant frequency is determined according to the following equation:

$${f}_{R} = \frac{1}{2 π \sqrt{L C}}$$

in which f_{R} is the resonant frequency, L is an inductance of the heating assembly and C is a capacitance of the heating assembly.
Example Ex19: An aerosol-generating device according to any one of Ex15 to Ex18, wherein the controller is configured, for the first heating mode, to apply only the alternating current or voltage to the inductor coil.
Example Ex20: An aerosol-generating device according to any one of Ex15 to Ex18, wherein the controller is configured, for one or both of the first and second heating modes, to apply a direct current or voltage to the inductor coil in addition to the alternating current.
Example Ex21: An aerosol-generating device according to Ex20, wherein the controller is configured to pause the application of the direct current or voltage to the inductor coil on switching to the second heating mode.
Example Ex22: An aerosol-generating device according to any one of Ex7 to Ex14, wherein the controller is configured to:
apply a direct current or voltage to the inductor coil for the first heating mode; and
on switching to the second heating mode, introduce an alternating current or voltage to the inductor coil, a frequency of the alternating current or voltage controlled such that all, a majority, or a substantial part of the thermal power dissipated by the heating assembly in response to the supply of alternating current or voltage arises from heating of the susceptor rather than heating of the inductor coil.
Example Ex23: An aerosol-generating device according to Ex22, wherein the controller is configured to pause the application of the direct current or voltage to the inductor coil on switching to the second heating mode.
Example Ex24: An aerosol-generating device according to Ex22, wherein the controller is configured to maintain the application of the direct current or voltage to the inductor coil over both the first and second heating modes.
Example Ex25: An aerosol-generating device according to any one of Ex7 to Ex24, wherein the controller is configured to:
apply one of first and second alternating current or voltages to the inductor coil for the first heating mode; and
apply the first and second alternating currents or voltages superposed with each other to the inductor coil for the second heating mode.
Example Ex26: An aerosol-generating device according to any one of Ex7 to Ex25, wherein the controller is configured to:
apply one of first and second direct currents or voltages to the inductor coil for the first heating mode; and
apply the first and second direct currents or voltages superposed with each other to the inductor coil for the second heating mode.
Example Ex27: An aerosol-generating device according to any one of Ex1 to Ex26, wherein the controller is configured to switch between applying different ones of the first and second waveforms to the inductor coil in response to receiving a signal indicative of an applied puff.
Example Ex28: An aerosol-generating device according to Ex7 or any Example dependent thereon, wherein the controller is configured to switch between the first and second heating modes in response to receiving a signal indicative of an applied puff.
Example Ex29: An aerosol-generating device according to either one of Ex27 or Ex28, wherein the controller is configured, in response to receiving the signal indicative of the applied puff, to reduce or deactivate resistance heating by the inductor coil and increase or activate heating of the susceptor through inductive coupling of the inductor coil with the susceptor.
Example Ex30: An aerosol-generating device according to any one of Ex27 to Ex29, wherein the controller is configured to determine a starting point and an end point of the applied puff and maintain the heating assembly in the second heating mode over the duration of the applied puff.
Example Ex31: An aerosol-generating device according to Ex30, wherein the controller is configured to switch from the second heating mode back to the first heating mode upon determination of the end point of the applied puff.
Example Ex32: An aerosol-generating device according to any one of Ex1 to Ex31, wherein the controller is configured to control a supply of electric energy to the inductor coil so as to maintain a temperature of the inductor coil at a target temperature or to follow a target temperature profile.
Example Ex33: An aerosol-generating device according to any one of Ex1 to Ex32, wherein the controller is configured to control a supply of electric energy to the inductor coil so as to maintain the temperature of the susceptor at a target temperature or to follow a target temperature profile.
Example Ex34: An aerosol-generating device according to any one of Ex1 to Ex33, wherein the aerosol-generating device comprises the susceptor.
Example Ex35: An aerosol-generating device according to Ex35, wherein the aerosol-generating device comprises a chamber, the inductor coil surrounding or at least partially defining a peripheral wall of the chamber, the susceptor arranged within the chamber, wherein the chamber is configured to receive an aerosol-generating article comprising the aerosol-forming substrate such that the susceptor extends within the aerosol-generating article.
Example Ex36: An aerosol-generating device according to Ex35, wherein the susceptor extends from a base of the chamber along a longitudinal axis of the chamber.
Example Ex37: An aerosol-generating device according to any one of Ex34 to Ex36, wherein the susceptor is formed as a pin or blade.
Example Ex38: An aerosol-generating system comprising an aerosol-generating device according to any one of Ex1 to Ex33, the aerosol-generating system further comprising an aerosol-generating article, the aerosol-generating article comprising the aerosol-forming substrate and the susceptor, the susceptor enclosed by or at least partially embedded within the aerosol-forming substrate.
Example Ex39: An aerosol-generating system according to Ex38, wherein the aerosol-generating device comprises a chamber, the inductor coil surrounding or at least partially defining a peripheral wall of the chamber, wherein the chamber is configured to receive the aerosol-generating article such that the susceptor is positioned at least partially within the inductor coil.
Example Ex40: A method of heating an aerosol-forming substrate to generate an aerosol therefrom, the method comprising:
providing a heating assembly comprising an inductor coil and a susceptor, the inductor coil positioned external to the aerosol-forming substrate, the susceptor enclosed within the aerosol-forming substrate, the susceptor positioned at least partially within the inductor coil;
providing power circuitry configured to generate first and second waveforms of electric power that are independently controllable of each other;
independently controlling application of the first and second waveforms to the inductor coil separately or simultaneously with each other to generate heat through one or a combination of:
   i) resistance heating by the inductor coil, for externally heating the aerosol-forming substrate, and
   ii) heating of the susceptor through inductive coupling of the inductor coil with the susceptor, for internally heating the aerosol-forming substrate.
Example Ex41: A method according to Ex40, wherein the (i) resistance heating by the inductor coil comprises applying one or more of:
a) an alternating current or voltage as the first waveform of electric power to the inductor coil at a frequency for inhibiting inductive coupling with the susceptor; and
b) a direct current or voltage as the first waveform of electric power to the inductor coil.
Example Ex42: A method according to either one of Ex40 or Ex41, wherein the (ii) heating of the susceptor through inductive coupling with the susceptor comprises applying an alternating current or voltage as the second waveform of electric power to the inductor coil at a frequency for promoting inductive coupling with the susceptor.
Example Ex43: A method according to any one of Ex40 to Ex42, the method comprising controlling the application of the first and second waveforms to the inductor coil to operate the heating assembly in each of:
a first heating mode in which a temperature inside a heating zone heated by the heating assembly is below a vaporisation or aerosolisation temperature of an aerosol-forming material of the aerosol-forming substrate; and
a second heating mode in which a temperature inside the heating zone heated by the heating assembly is at or above the vaporisation or aerosolisation temperature.
Example Ex44: A method according to Ex43, the method further comprising controlling the application of the first and second waveforms to the inductor coil to adjust a ratio of a power dissipated by resistance heating of the inductor coil to a power dissipated by heating of the susceptor through inductive coupling of the inductor coil with the susceptor from a first ratio for the first heating mode to a second ratio for the second heating mode.
Example Ex45: A method according to either one of Ex43 or Ex44, the method further comprising applying or adjusting a frequency of an alternating current or voltage to the inductor coil when switching between the first and second heating modes so as to change the inductive coupling of the inductor coil with the susceptor.
Example Ex46: A method according to any one of Ex43 to Ex45, the method further comprising adjusting an amplitude of an alternating current or voltage to the inductor coil when switching between the first and second heating modes such that the amplitude differs for the second heating mode relative to the first heating mode.
Example Ex47: A method according to any one of Ex43 to Ex46, the method further comprising adjusting an amplitude of a direct current or voltage to the inductor coil when switching between the first and second heating modes such that the amplitude differs for the second heating mode relative to the first heating mode.
Example Ex48: A method according to any one of Ex43 to Ex47, the method further comprising simultaneously applying both an alternating current or voltage and a direct current or voltage to the inductor coil for one or both of the first and second heating modes.
Example Ex49: A method according to any one of Ex43 to Ex48, the method further comprising simultaneously applying both a first alternating current or voltage as the first waveform of electric power and a second alternating current or voltage as the second waveform of electric power to the inductor coil for one or both of the first and second heating modes, one of the first and second alternating currents or voltages providing a greater degree of inductive coupling than the other of the first and second alternating currents or voltages.
Example Ex50: A method according to any one of Ex43 to Ex48, the method further comprising:
applying only an alternating current or voltage as one of the first and second waveforms to the inductor coil for one of the first and second heating modes, and
applying only a direct current or voltage as the other of the first and second waveforms to the inductor coil for the other of the first and second heating modes
Example Ex51: A method according to any one of Ex43 to Ex49, the method further comprising:
applying an alternating current or voltage to the inductor coil for both of the first and second heating modes; and
adjusting a frequency of the alternating current or voltage applied to the inductor coil when switching between the first and second heating modes so as to change the inductive coupling of the inductor coil with the susceptor.
Example Ex52: A method according to Ex51, the method further comprising adjusting the frequency of the alternating current or voltage applied to the inductor coil when switching between the first and second heating modes so as to increase the inductive coupling of the inductor coil with the susceptor.
Example Ex53: A method according to either one of Ex51 or Ex52, the method further comprising adjusting the frequency of the alternating current or voltage applied to the inductor coil from a first value or range of values for the first heating mode to a second value or range of values for the second heating mode, wherein the second frequency value or range of values is closer than the first frequency value or range of values to a resonant frequency of the heating assembly.
Example Ex54: A method according to Ex53, wherein the resonant frequency is determined according to the following equation:

$${f}_{R} = \frac{1}{2 π \sqrt{L C}}$$

in which f_{R} is the resonant frequency, L is an inductance of the heating assembly and C is a capacitance of the heating assembly.
Example Ex55: A method according to any one of Ex51 to Ex54, the method comprising, for the first heating mode, applying only the alternating current or voltage to the inductor coil.
Example Ex56: A method according to any one of Ex51 to Ex54, the method comprising, for one or both of the first and second heating modes, applying a direct current or voltage to the inductor coil in addition to the alternating current.
Example Ex57: A method according to Ex56, comprising pausing the application of the direct current or voltage to the inductor coil on switching to the second heating mode.
Example Ex58: A method according to any one of Ex43 to Ex50, the method further comprising:
applying a direct current or voltage to the inductor coil for the first heating mode; and
on switching to the second heating mode, introducing an alternating current or voltage to the inductor coil, a frequency of the alternating current or voltage being controlled such that all, a majority, or a substantial part of the thermal power dissipated by the heating assembly in response to the supply of alternating current or voltage arises from heating of the susceptor rather than heating of the inductor coil.
Example Ex59: A method according to Ex58, the method comprising pausing the application of the direct current or voltage to the inductor coil on switching to the second heating mode.
Example Ex60: A method according to Ex58, the method comprising maintaining the application of the direct current or voltage over both the first and second heating modes.
Example Ex61: A method according to any one of Ex43 to Ex60, the method further comprising:
applying one of first and second alternating current or voltages to the inductor coil for the first heating mode; and
applying the first and second alternating currents or voltages superposed with each other to the inductor coil for the second heating mode.
Example Ex62: A method according to any one of Ex43 to Ex61, the method further comprising:
applying one of first and second direct currents or voltages to the inductor coil for the first heating mode; and
applying the first and second direct currents or voltages superposed with each other to the inductor coil for the second heating mode.
Example Ex63: A method according to any one of Ex40 to Ex62, the method further comprising switching between applying different ones of the first and second waveforms to the inductor coil in response to receiving a signal indicative of an applied puff.
Example Ex64: A method according to Ex43 or any Example dependent thereon, the method further comprising:
switching between the first and second heating modes in response to receiving a signal indicative of an applied puff.
Example Ex65: A method according to either one of Ex63 or Ex64, the method further comprising:
in response to receiving the signal indicative of the applied puff, reducing or deactivating resistance heating by the inductor coil and increasing or activating heating of the susceptor through inductive coupling of the inductor coil with the susceptor.
Example Ex66: A method according to any one of Ex63 to Ex65, the method further comprising determining a starting point and an end point of the applied puff and maintaining the heating assembly in the second heating mode over the duration of the applied puff.
Example Ex67: A method according to Ex66, the method further comprising switching from the second heating mode back to the first heating mode upon determination of the end point of the applied puff.
Example Ex68: A method according to any one of Ex40 to Ex67, the method further comprising controlling a supply of electric energy from the power circuitry to the inductor coil so as to maintain a temperature of the inductor coil at a target temperature or to follow a target temperature profile.
Example Ex69: A method according to any one of Ex40 to Ex68, the method comprising controlling a supply of electric energy from the power circuitry to the inductor coil so as to maintain a temperature of the susceptor at a target temperature or to follow a target temperature profile.

The invention is further described, by way of example only, with reference to the accompanying drawings in which:

FIG. 1 shows a side cross-sectional view of an aerosol-generating device according to a first embodiment;

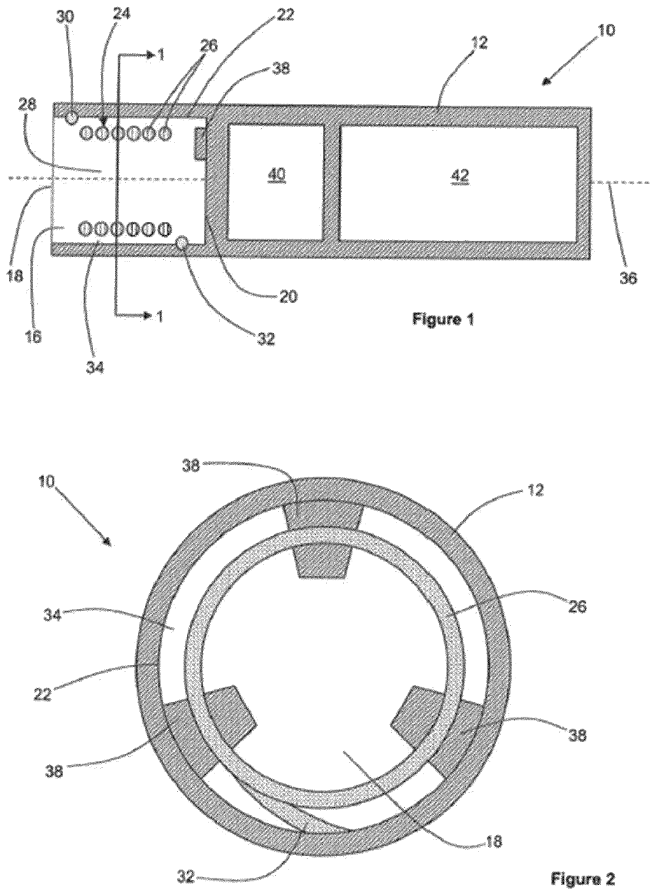

FIG. 2 shows an axial cross-sectional view of the aerosol-generating device of FIG. 1 along line 1-1;

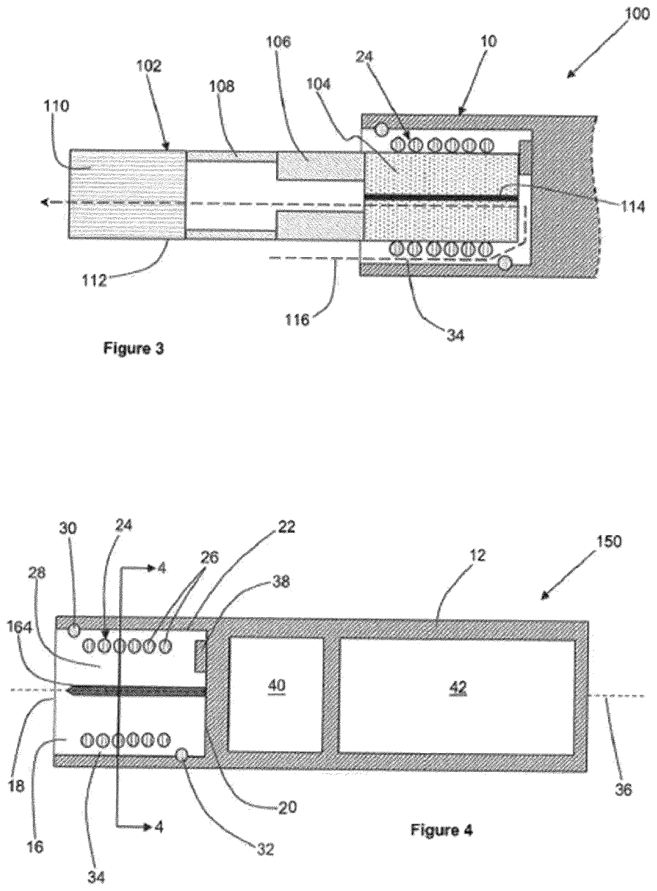

FIG. 3 shows a side cross-sectional view of an aerosol-generating system comprising the aerosol-generating device of FIG. 1;

FIG. 4 shows a side cross-sectional view of an aerosol-generating device according to a second embodiment;

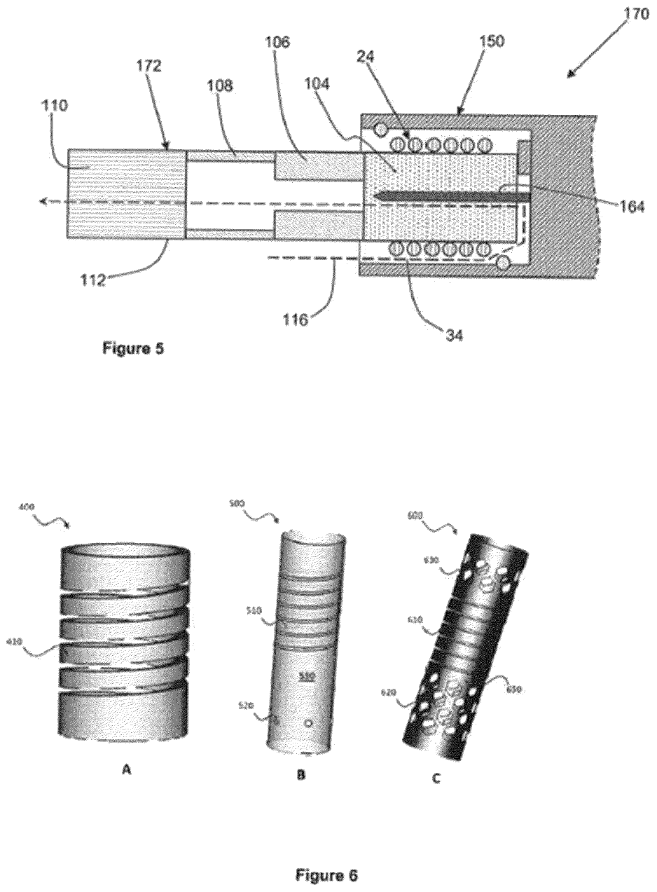

FIG. 5 shows a side cross-sectional view of an aerosol-generating system comprising the aerosol-generating device of FIG. 4;

FIG. 6 illustrates possible forms of inductor coil for the devices illustrated in FIGS. 1 to 5;

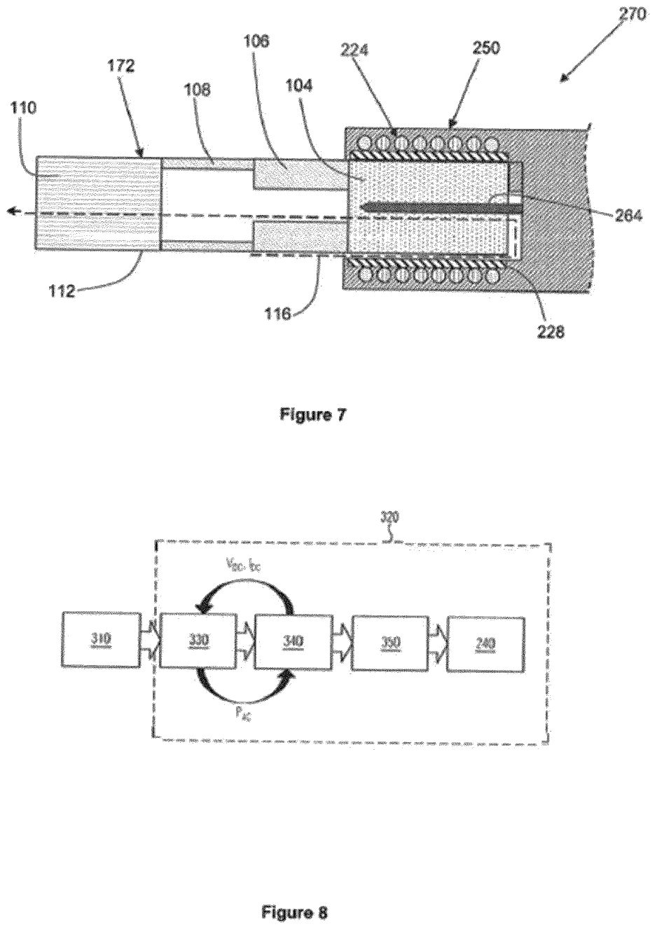

FIG. 7 illustrates the provision of a thermal bridging element between an inductor coil and an aerosol-generating article;

FIG. 8 is a block diagram showing an inductive heating arrangement of the aerosol-generating devices described in relation to FIGS. 1 to 5;

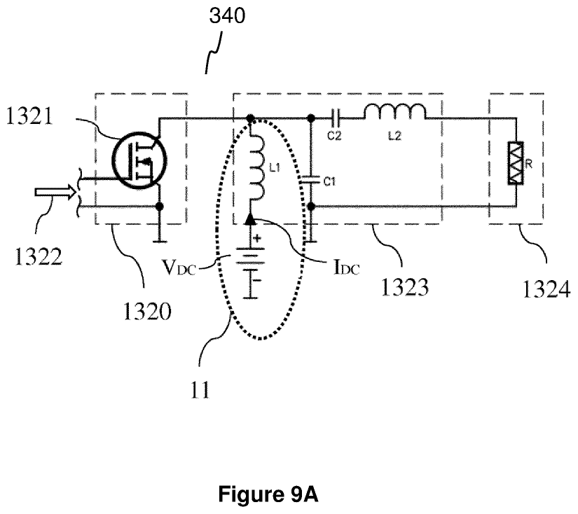

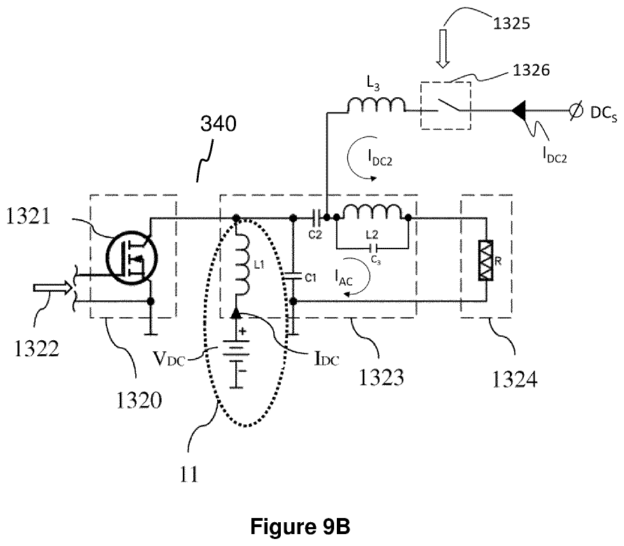

FIG. 9A is a schematic diagram showing a first embodiment of power circuitry of the aerosol-generating devices described in relation to FIGS. 1 to 5;

FIG. 9B is a schematic diagram showing a second embodiment of power circuitry of the aerosol-generating devices described in relation to FIGS. 1 to 5;

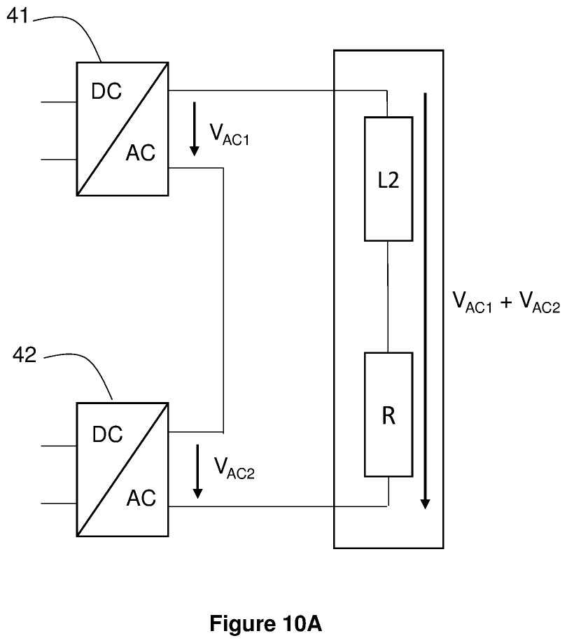

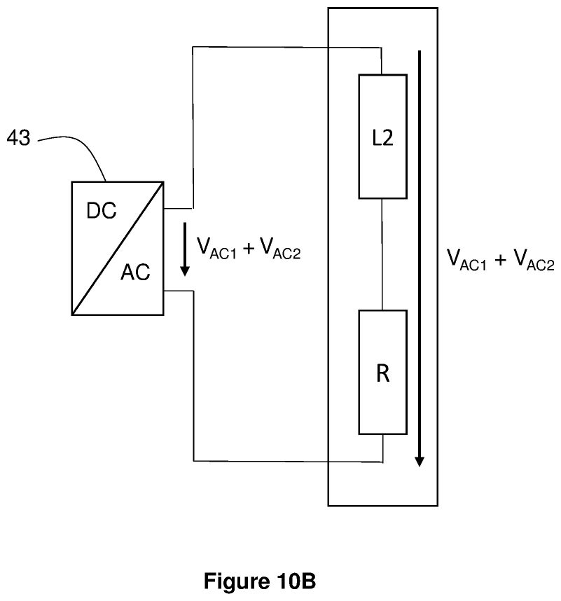

FIG. 10A shows an arrangement of a first voltage source and a second voltage source arranged to apply superposed respective first and second voltage waveforms to an inductor coil of an inductive heating arrangement.

FIG. 10B shows an arrangement of a single voltage source arranged to apply superposed respective first and second voltage waveforms to an inductor coil of an inductive heating arrangement.

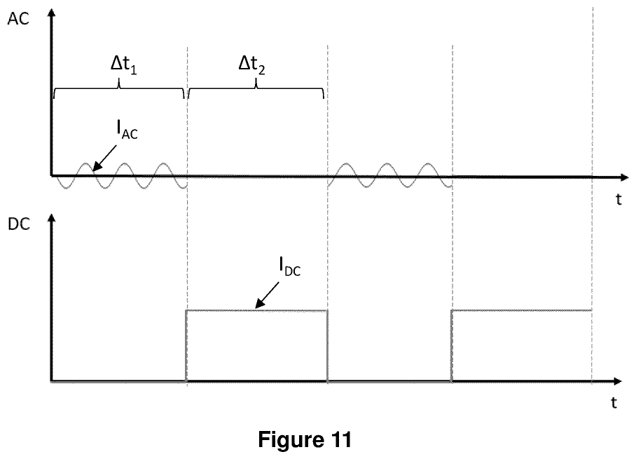

FIG. 11 illustrates the alternate application of AC and DC current waveforms to an inductor coil of an inductive heating arrangement in successive phases of operation;

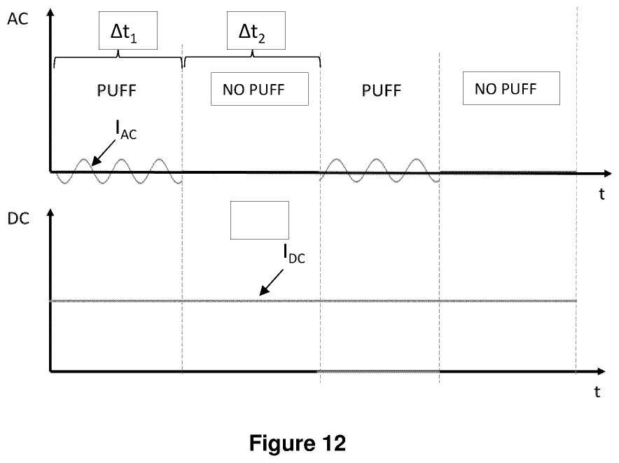

FIG. 12 illustrates the alternate application and removal of an AC current waveform to an inductor coil of an inductive heating arrangement in successive phases of operation, and the continuous application of a DC current waveform over the successive phases.

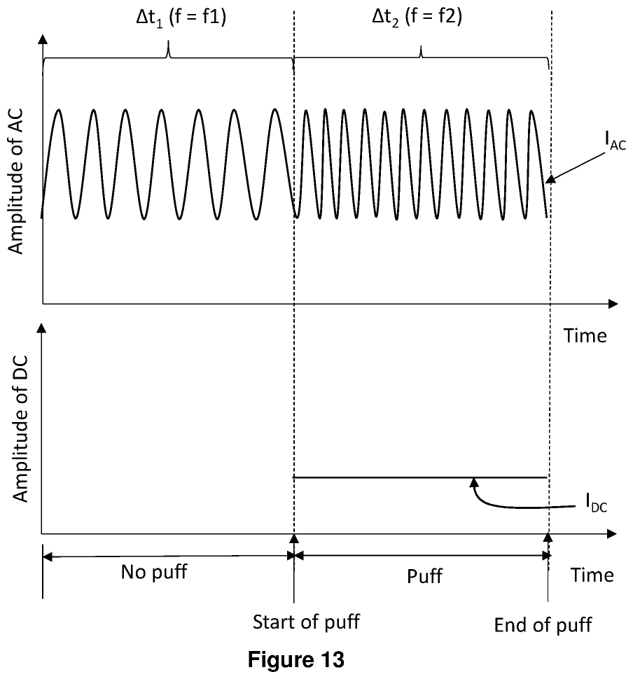

FIG. 13 illustrates the application of an AC current waveform to an inductor coil of an inductive heating arrangement over successive phases of operation, with a change in frequency of the AC current waveform and the introduction of a DC current waveform occurring on switching between the phases;

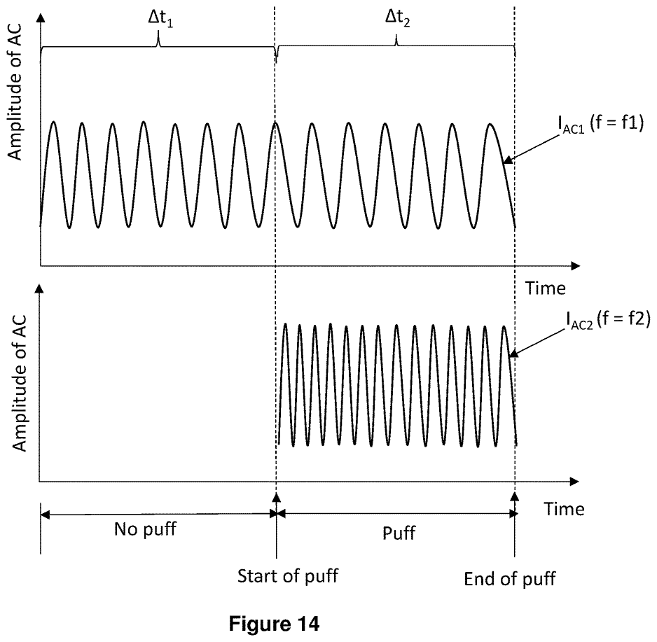

FIG. 14 illustrates the application of a first AC current waveform to an inductor coil of an inductive heating arrangement over successive phases of operation, and the introduction of a second AC current waveform on switching between the phases.

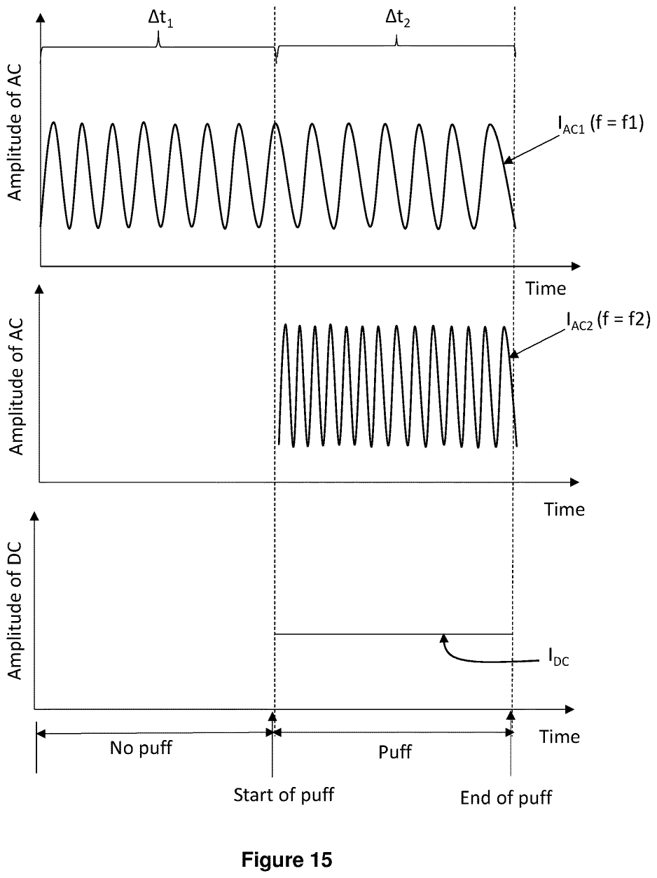

FIG. 15 illustrates the application of a first AC current waveform to an inductor coil of an inductive heating arrangement over successive phases of operation, and the introduction of a second AC current waveform and a first DC current waveform on switching between the phases.

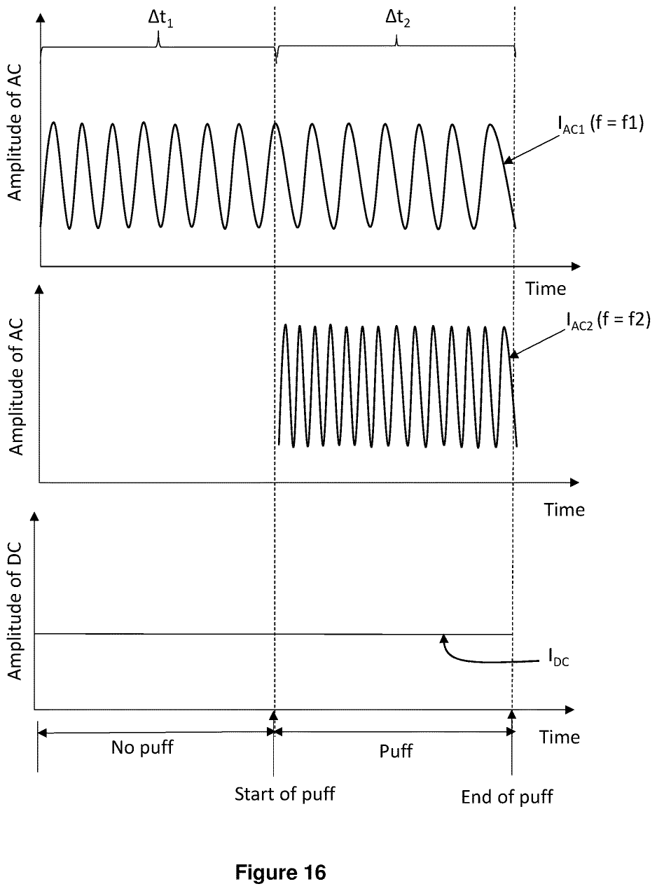

FIG. 16 illustrates the application of a first AC current waveform and a first DC current waveform to an inductor coil of an inductive heating arrangement over successive phases of operation, and the introduction of a second AC current waveform on switching between the phases.

FIGS. 1 and 2 show an aerosol-generating device 10 in accordance with a first embodiment. The aerosol-generating device 10 comprises a housing 12 defining a chamber 16 for receiving a portion of an aerosol-generating article. The chamber 16 comprises an open end 18 through which an aerosol-generating article may be inserted into the chamber 16 and a closed end 20 opposite the open end 18. A cylindrical wall 22 of the chamber 16 extends between the open end 18 and the closed end 20.

The aerosol-generating device 10 also comprises an inductor coil 24 comprising a plurality of windings 26 disposed within the chamber 16. The plurality of windings 26 of the inductor coil 24 define a lumen 28 in which a portion of an aerosol-generating article is received when the aerosol-generating article is inserted into the chamber 16. Advantageously, positioning the inductor coil 24 in direct contact with an aerosol-generating article received within the chamber 16 facilitates the transfer of heat generated by resistive heating of the inductor coil 24 to the aerosol-generating article.

The inductor coil 24 comprises a first end 30 positioned towards the open end 18 of the chamber 16 and a second end 32 positioned towards the closed end 20 of the chamber 16. Each of the first end 30 and the second end 32 is received within a portion of the cylindrical wall 22 of the chamber 16 to retain the inductor coil 24 within the chamber 16. The cylindrical wall 22 of the chamber 16 may define first and second recesses, slots, or apertures in which the first and second ends 30, 32 of the inductor coil 24 are respectively received. Alternatively, the first and second ends 30, 32 of the inductor coil 24 may be secured to the cylindrical wall 22 of the chamber 16 by overmoulding the housing 12 over the first and second ends 30, 32 of the inductor coil 24 during manufacture of the housing 12.

The inductor coil 24 is suspended within the chamber 16 by the first and second ends 30, 32 of the inductor coil 24 so that the windings 26 of the inductor coil 24 are spaced apart from the cylindrical wall 22 of the chamber 16. Therefore, the inductor coil 24 contacts the housing 12 only at the first and second ends 30, 32 of the inductor coil 24. Spacing the windings 26 of the inductor coil 24 from the cylindrical wall 22 of the chamber 16 defines an annular gap 34 between the cylindrical wall 22 of the chamber 16 and the windings 26 of the inductor coil 24. Advantageously, the annular gap 34 reduces or minimises the transfer of heat generated by resistive heating of the inductor coil 24 to the housing 12. Advantageously, the annular gap 34 facilitates airflow through the chamber 16 when an aerosol-generating article is received within the chamber 16.

To facilitate insertion of an aerosol-generating article into the chamber 16, the inductor coil 24 is arranged concentrically about a central axis 36 of the aerosol-generating device 10. To facilitate a secure positioning of the inductor coil 24 in the chamber 16, the first and second ends 30, 32 of the inductor coil 24 are retained by diametrically opposed portions of the cylindrical wall 22 of the chamber 16.

The housing 12 also defines a plurality of protrusions 38 extending into the chamber 16 from the closed end 20 of the chamber 16. As will be further described below, the plurality of protrusions 38 function to maintain a gap between an end of an aerosol-generating article and the closed end 20 of the chamber 16 when the aerosol-generating article is fully inserted into the chamber 16. In the embodiment shown in FIGS. 1 and 2, the housing 12 defines three protrusions 38 spaced equidistantly about the central axis 36 of the aerosol-generating device 10. The skilled person will appreciate that the housing 12 may define more or fewer protrusions 38 and the arrangement of the protrusions 38 at the closed end 20 of the chamber 16 may be varied.

The aerosol-generating device 10 also comprises control circuitry 40 and a power supply 42 connected to the inductor coil 24. The control circuitry 40 is configured to provide an alternating electric current from the power supply 42 to the inductor coil 24 to generate an alternating magnetic field. The control circuitry 40 may also be configured to provide a direct current from the power supply 42 to the inductor coil 24.

For example, the control circuitry 40 can include a power circuitry that is controlled by a controller, for example a controller that can generate modulation signals to control the power circuitry to generate first and second waveforms. By way of example, the controller may be configured to generate two different pulse-width modulation (PWM) signals for a desired voltage/current waveform, with these signals being applied to one or more power converters, for example two DC/AC voltage converters arranged in series, each receiving one of the two modulation signals. The modulation signals could also be superposed, for example to be fed to a single DC/AC voltage or current converter in order to generate a superposed power signal, either voltage or current. It will be appreciated that the power circuitry may have a combination of voltage and current converters.

FIG. 3 shows a cross-sectional view of an aerosol-generating system 100 comprising the aerosol-generating device 10 of FIG. 1 and an aerosol-generating article 102.

The aerosol-generating article 102 comprises an aerosol-forming substrate 104 in the form of a tobacco plug, a first hollow acetate tube (HAT) 106, a second hollow acetate tube (HAT) 108, a mouthpiece 110, and an outer wrapper 112. The aerosol-generating article 102 also comprises a susceptor element 114 arranged within the aerosol-forming substrate 104. During use, a portion of the aerosol-generating article 102 is inserted into the chamber 16 and the inductor coil 24 so that the aerosol-forming substrate 104 and the susceptor element 114 are positioned inside the lumen 28 defined by the inductor coil 24. The control circuitry 40 provides an alternating electric current from the power supply 42 to the inductor coil 24 to generate an alternating magnetic field that inductively heats the susceptor element 114, which heats the aerosol-forming substrate 104 to generate an aerosol. As is described in more detail below, the level of inductive coupling between the inductor coil 24 and the susceptor element 114 (and consequently, the heating of the susceptor 114) is affected by the frequency of the alternating current to the inductor coil 24. Where the control circuitry 40 is also configured to provide a direct current from the power supply 42 to the inductor coil 24, the direct current results in resistance heating of the inductor coil 24.

Airflow through the aerosol-generating system 100 during use is illustrated by the dashed line 116 in FIG. 3 in an exemplary non-limiting embodiment. When a user draws on the mouthpiece 110 of the aerosol-generating article 102, a negative pressure is generated in the chamber 16. The negative pressure draws air into the chamber 16 via the open end 18 of the chamber. The air entering the chamber 16 then flows through the annular gap 34 between the inductor coil 24 and the cylindrical wall 22 of the chamber 16. When the airflow reaches the closed end 20 of the chamber 16, the air enters the aerosol-generating article 102 through the aerosol-forming substrate 104. Airflow into the aerosol-generating article 102 is facilitated by the gap maintained between the upstream end of the aerosol-generating article 102 and the closed end 20 of the chamber 16 by the plurality of protrusions 38. As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

FIG. 4 shows a cross-sectional view of an aerosol-generating device 150 according to a second embodiment. The aerosol-generating device 150 is similar to the aerosol-generating device 10 described with reference to FIGS. 1 and 2 and like reference numerals are used to designate like parts.

The aerosol-generating device 150 differs from the aerosol-generating device 10 by the addition of a susceptor element 164. The susceptor element 164 has an elongate shape and extends into the chamber 16 from the closed end 20 of the chamber 16. The susceptor element 164 extends along the central axis 36 of the aerosol-generating device 150 so that the inductor coil 24 extends concentrically around the susceptor element 164.

FIG. 5 shows a cross-sectional view of an aerosol-generating system 170 comprising the aerosol-generating device 150 of FIG. 4 and an aerosol-generating article 172. The aerosol-generating system 170 is similar to the aerosol-generating system 100 described with reference to FIG. 3 and like reference numerals are used to designate like parts.

The aerosol-generating system 170 differs from aerosol-generating system 100 by the absence of a susceptor element as part of the aerosol-generating article 172. When the aerosol-generating article 172 is inserted into the chamber 16, the susceptor element 164 of the aerosol-generating device 150 is received within the aerosol-forming substrate 104 of the aerosol-generating article 172. FIGS. 4 and 5 show the susceptor element 164 as having a pin- or blade-shaped profile, thereby facilitating penetration of the aerosol-forming substrate 104 by the susceptor element 164 during insertion of the aerosol-generating article 172 into the chamber 16 of the aerosol-generating device 150. The skilled person will appreciate that the susceptor element 164 may have a profile other than that shown in FIGS. 4 and 5.

Once the aerosol-generating article 172 has been inserted into the chamber 16, the operation of the aerosol-generating system 170 is identical to the operation of the aerosol-generating system 100 described with reference to FIG. 3.

FIG. 6 illustrates three possible alternative coil structures for the devices illustrated in FIGS. 1 to 5.

A first coil structure is marked as coil structure A. Coil structure A comprises a sleeve 400. A helical coil section 410 is formed by removal of material from the sleeve 400.

An insulating material may be arranged within the gaps where the material of the sleeve 400 has been removed. This has the advantage of structurally reinforcing the coil structure and may also facilitate the insertion of the aerosol generating article. It is also possible to wrap or overmould a layer of insulating material, like polyimide tape, around the helical coil section 410 or the sleeve 400. This would not significantly interfere with the heat transferred to the aerosol generating article but would improve the structural stability of the coil structure.

A second coil structure, marked as coil structure B, comprises a sleeve 500 similar to coil structure A including a helical coil section 510 obtained by material removal. Sleeve 500 comprises a downstream extended portion 550 which is used to couple the sleeve within the housing 12 of the chamber 16 of the aerosol-generating device. Extended portion 550 comprises through-holes 520 to allow airflow through the sleeve and into the aerosol generating article.

A third coil structure, coil structure C, comprises a sleeve 600 with a helical coil section 610 and a downstream extended region 650, which comprises through-holes 620 which are greater in size and in number than for the through-holes 520 of coil structure B. When compared to coil structure B, bigger openings 620 offer the advantage of reducing the mass of the structure and therefore significantly mitigates heat losses caused by heat conduction towards end regions of the sleeve.

Although the devices described so far all use helical shaped coils, it is possible to use other forms of inductor coil. In particular, one or more flat spiral coils or pancake coils could be used to both generate an alternating magnetic field within the chamber 16 and to provide for external heating from resistive heating of the coil itself. Such flat spiral coils could be shaped to conform to the side wall of the chamber and arranged to generate a magnetic field orthogonal to a longitudinal axis of the chamber.

FIG. 7 shows a cross-sectional view of an aerosol-generating device 250 according to a third embodiment. The aerosol-generating device 250 is similar to the aerosol-generating device 150 described with reference to FIGS. 4 and 5 and like reference numerals are used to designate like parts.

The embodiment of FIG. 7 differs from the embodiment of FIGS. 4 and 5 in the position of the inductor coil 224 and in the provision of a thermal bridging element 228 between the coil 224 and the aerosol generating article 172. The inductor coil 224 is embedded or recessed within the housing of the device 250, and the thermal bridging element 228 formed from a thermally conductive material is placed in contact with the inductor coil 224. The thermal bridging element 228 is in the form of an austenitic steel tube. The thermal bridging element 228 partially defines a cylindrical wall of the chamber that extends between the open end and the closed end of the chamber. The thermal bridging element 228 is arranged so that an aerosol-generating article 172 is received within the thermal bridging element 228 and in direct contact with the thermal bridging element 228 when the aerosol-generating article is inserted into the chamber. Advantageously, direct contact between the thermal bridging element 228 and an aerosol-generating article 172 facilitates the transfer of heat from the thermal bridging element 228 to the aerosol-generating article.

The inductor coil 224 comprises a plurality of windings that extend around an outer surface of the thermal bridging element 228. The inductor coil 224 is arranged so that the plurality of windings are in direct contact with the outer surface of the thermal bridging element 228. Advantageously, positioning the inductor coil 224 in direct contact with an outer surface of the thermal bridging element 228 facilitates the transfer of heat generated by resistive heating of the inductor coil 224 to the thermal bridging element 228. The inductor coil 224 and the thermal bridging element 228 are arranged concentrically about a central axis of the aerosol-generating device 250.

The control of the devices described in FIGS. 1 to 7 will now be explained in detail.

FIG. 8 is a block diagram illustrating an exemplary configuration of components and circuitry for generating and providing an alternating current to an inductor coil of an aerosol-generating device, such as the inductor coil 24 of the aerosol-generating devices 10, 150 of FIGS. 1 and 4. A DC power source 310 is coupled to an inductive heating arrangement 320. The heating arrangement 320 comprises a controller 330, a DC/AC converter 340, a matching network 350 and an inductor coil 240. The DC power source 310 of FIG. 8 corresponds to the power supply 42 of the aerosol-generating devices 10, 150 of FIGS. 1 and 4. The controller 330, DC/AC converter 340 and matching network 350 correspond to the control circuitry 40 of the aerosol-generating devices 10, 150 of FIGS. 1 and 4. The inductor coil 240 corresponds to the inductor coil 24 of the aerosol-generating devices 10, 150 of FIGS. 1 and 4. The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device, such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor coil 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

The controller 330 is configured to provide one or more modulation signals to control the output voltage and/or current of the DC/AC converter 340, for example by pulse-width modulation (PWM), step modulation, or other type of modulation.

FIG. 9A schematically illustrates a first embodiment of power circuitry for use in supplying the inductor coil 240 with electric energy. The power circuitry includes the DC/AC converter 340. The DC/AC converter 340 preferably comprises a Class-E power amplifier. The Class-E power amplifier comprises a transistor switch 1320 comprising a Field Effect Transistor 1321, for example a Metal-Oxide-Semiconductor Field Effect Transistor (MOSFET), a transistor switch supply circuit indicated by the arrow 1322 for supplying a switching signal (gate-source voltage) to the Field Effect Transistor 1321, and an LC load network 1323 comprising a shunt capacitor C1 and a series connection of a capacitor C2 and inductor coil L2. Inductor coil L2 corresponds to inductor coil 240 of FIG. 8. In addition, DC power source 11, comprising a choke inductor L1, is shown for supplying the DC supply voltage V_{DC}, with the DC current I_{DC} being drawn from the DC power source 11 during operation. The ohmic resistance R represents the total ohmic load 1324, which is the sum of the ohmic resistance R_{coil} of the inductor coil L2 and the ohmic resistance R_{load} of the susceptor element. The DC power source 11 corresponds to the DC power source 310 of FIG. 8.

The transistor switch supply circuit 1322 may supply a switching voltage having a rectangular profile to the Field Effect Transistor 1321. As long as the Field Effect Transistor 1321 is conducting (in an “on”-state), it essentially constitutes a short circuit (low resistance) so that the entire current flows through the choke L₁ and the Field Effect Transistor 1321. When the Field Effect Transistor 1321 is non-conducting (in an “off”-state), the entire current flows into the LC load network 1323 since the Field Effect Transistor 1321 essentially represents an open circuit (high resistance). Switching the Field Effect Transistor 1321 between conducting (“on”) and non-conducting (“off”) states inverts the supplied DC voltage V_{DC} and DC current I_{DC} into an AC voltage V_{AC} and AC current I_{AC} flowing into the inductor coil L2, having frequency f. Choke inductor L1 prevents the flow of AC current through DC source V_{DC}.

In an alternative mode of operation, the transistor switch supply circuit 1322 is inactive so that the supplied DC current I_{DC} is not converted to AC current, but remains as direct current.

So, the circuit of FIG. 9A allows for supplying the inductor coil L2 with one of two different waveforms of electric power at a given point in time-either a waveform formed of AC current I_{AC} or a waveform formed of DC current I_{DC}, but not both I_{AC} and I_{DC} simultaneously.

FIG. 9B schematically illustrates a second embodiment of power circuitry for use in supplying the inductor coil 240 with electric energy. The power circuitry of FIG. 9B includes all of the components of the circuitry of FIG. 9A, but also includes additional circuitry. The additional circuitry is discussed below.

A DC feed to the inductor coil L2 is provided. More specifically, a DC power supply DC_{S} is connected to the inductor coil L2 through a transistor switch 1326. A choke inductor L3 is downstream of the DC power supply DC_{S}.

The transistor switch 1326 is driven by a transistor switch supply circuit indicated by the arrow 1325 for supplying the switching signal (gate-source voltage). The DC power source DC_{S} may be a battery or in general any means capable of producing a DC current. In particular, the battery could be the same power source as the one generating the DC voltage V_{DC} for feeding to the DC/AC converter 340 in order to generate the AC current I_{AC}. When the switch 1326 is activated, a DC current I_{DC2} flows through inductors L3 and L2.

Choke inductor L3 prevents the AC current I_{AC} from flowing through the DC source DC_{S}. For this purpose, advantageously the inductance of L3 is significantly higher than the inductance of inductor coil L2.

The circuit of FIG. 9B allows the simultaneous or sequential flow of a) AC current I_{AC} (generated from V_{DC}) flowing through capacitor C2, inductor coil L2 and capacitor C1, and b) direct current I_{DC2} through inductor L3 and inductor coil L2. Direct current I_{DC2} does not reach choke inductor L1 because of the presence of capacitor C2, which is seen by I_{DC2} as an open circuit. The AC current I_{AC} and the direct current I_{DC2} form different waveforms of electric power which may be simultaneously or sequentially supplied to the inductor coil L2.

The circuit could also operate without the choke inductor L3, as long as the circuit is set up for operating sequentially with AC current and DC current (specifically, AC and DC are not to be activated simultaneously).

As explained in detail below, it is also possible to resistively heat the inductor coil L2 by the AC current I_{AC} if the frequency of the AC current I_{AC} is such that there is little coupling to the susceptor element. It could also be advantageous to add a capacitor C3 in parallel to inductor coil L2, as shown in FIG. 9B. In this way, inductor coil L2 is more frequency selective. As explained below, the presence of capacitor C3 may greatly improve the process of switching from a frequency f_{susceptor} to a frequency f_{inductor coil} to thereby change from internal to external heating of the aerosol-forming substrate as a result of AC current, since the difference between the two frequency values may be significantly reduced. In this way, the control may run smoother. Without capacitor C3, the two frequency values (f_{susceptor}, f_{inductor coil}) may be distant from each other, making the system slower to react.

Although the DC/AC converter 340 is illustrated as comprising a Class-E power amplifier, the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 8, the inductor coil 240 may receive the alternating current from the DC/AC converter 340 via the matching network 350 for optimum adaptation to the load, but the matching network 350 is not essential. The matching network 350 may comprise a small matching transformer. The matching network 350 may improve power transfer efficiency between the DC/AC converter 340 and the inductor coil 240.

As illustrated in FIGS. 1 and 4, the inductor coil 24 is located around the chamber 16 of the aerosol-generating device 10, 150. Accordingly, high frequency alternating current I_{AC} may be supplied to the inductor coil 24 during operation of the aerosol-generating device 10, 150 to cause the inductor coil to generate a high frequency alternating magnetic field within the chamber 16 of the aerosol-generating device 10, 150. The high frequency alternating current I_{AC} and resulting alternating magnetic field preferably has a frequency sufficient to promote inductive coupling between the inductor coil 24 and the susceptor element 114, 164. The alternating magnetic field preferably has a frequency of between 1 and 30 megahertz, preferably between 2 and 10 megahertz, for example between 5 and 7 megahertz. As can be seen from FIGS. 3 and 5, when an aerosol-generating article 102, 172 is inserted into the chamber 16, the aerosol-forming substrate 104 of the aerosol-generating article is located adjacent to and at least partially within the inductor coil 24 so that the susceptor element 114, 164 is located within this alternating magnetic field. When the alternating magnetic field penetrates the susceptor element 114, 164, the alternating magnetic field causes heating of the susceptor element. For example, eddy currents are generated in the susceptor element 114, 164, which is heated as a result. Further heating may be provided by magnetic hysteresis losses within the susceptor element 114, 164.

Similarly, when the inductor coil 24 itself is resistively heated by the DC current I_{DC2} (and/or by AC current I_{AC} having a frequency which inhibits coupling between the inductor coil 24 and the susceptor element 114, 164), heat is transferred to the aerosol-generating article 102, 172 located adjacent to the inductor coil 24.

In one heating mode, the heated susceptor element 114, 164 and/or the heated inductor coil 24 are capable of heating the aerosol-forming substrate 104 of the aerosol-generating article 102, 172 to a sufficient temperature to form an aerosol. The aerosol is drawn downstream through the aerosol-generating article 102, 172 and inhaled by the user. However, in another heating mode, the heated susceptor element 114, 164 and/or the heated inductor coil 24 are capable of providing a lower level of heating to the aerosol-forming substrate 104 below the temperature necessary to generate aerosol from the aerosol-forming substrate.

The controller 330 may be a microcontroller, preferably a programmable microcontroller. The controller 330 is programmed to provide one or more modulation signals to regulate the supply of power from the DC power source 310 to the inductive heating arrangement 320 in order to control the temperature of the susceptor element. The controller 330 and/or the control circuitry 40 may also configured to detect the application of a puff to the aerosol-generating article 102, 172 inserted into the aerosol-generating device 10, 150; by way of example, the aerosol-generating device 10, 150 may include an airflow sensor, a pressure sensor or a temperature sensor coupled to the controller 330 or the control circuitry 40.

The waveforms of electric power as provided to the inductor coil may differ in form from those provided by the power circuitry of FIGS. 9A and 9B. By way of example, FIG. 10A illustrates an exemplary arrangement of a first voltage source 41 and a second voltage source 42 arranged to apply superposed respective first and second voltage waveforms V_{AC1}, V_{AC2} to the inductor coil L2. FIG. 10B illustrates an exemplary arrangement of a single voltage source 43 arranged to apply superposed respective first and second voltage waveforms V_{AC1}, V_{AC2} to the inductor coil L2.

FIG. 11 illustrates an exemplary scheme for supplying current to the inductor coil 24, 240. In the scheme shown in FIG. 11, the supply of current alternates between AC current I_{AC} and DC current I_{DC} in successive phases. The phases preferably form part of a usage session of the aerosol-generating device 10, 150 in the consuming of the aerosol-forming substrate 104 of the aerosol-generating article 102, 172. The AC current I_{AC} and the DC current I_{DC} define respective first and second waveforms of electric power. The scheme of FIG. 11 may be implemented using the power circuitry of either FIG. 9A or FIG. 9B. The AC current I_{AC} has a frequency at or close to frequency f_{susceptor}, in which the AC current I_{AC} creates a varying magnetic field that best couples with the susceptor element 114, 164. The generation of AC current I_{AC} at or close to frequency f_{susceptor} allows the transfer of almost the totality of the energy in the flow of AC current I_{AC} through the inductor coil 24, 240 to the susceptor element 114, 164, resulting in the aerosol-forming substrate 104 being solely or predominantly heated internally by heating of the susceptor element over a first phase of operation (having duration Δt₁). As the flow of DC current I_{DC} does not generate a varying magnetic field, the supply of the DC current I_{DC} results in the aerosol-forming substrate 104 being solely heated externally by resistance heating of the inductor coil 24, 240 over a second phase of operation (having duration Δt₂). It will be appreciated that a change in amplitude of the AC current I_{AC} or the DC current I_{DC} will result in a corresponding change in the level of heating arising from the respective current. If the AC current I_{AC} is controlled to have a frequency further away from f_{susceptor}, then the AC current I_{AC} will result in an increased level of heating provided by resistance heating of the inductor coil 24, 240, with less heating provided by the susceptor element 114, 164. If the AC current I_{AC} is controlled to have a frequency at or close to frequency fₜₒₜₐₗ, the AC current I_{AC} results in a simultaneous combination of heating of the susceptor element 114, 164 and resistance heating of the inductor coil 24, 240, thereby heating the aerosol-forming substrate 104 both internally and externally. In a preferred embodiment, the application of the DC current I_{DC} may correspond to a “maintenance” heating mode and the application of the AC current I_{AC} waveform may correspond to a “boost” heating mode. Alternatively, the DC current I_{DC} waveform may be associated with the boost heating mode and the AC current I_{AC} associated with the maintenance heating mode. The boost and maintenance heating modes provide different levels of heating to the aerosol-forming substrate 104. In the maintenance heating mode, the aerosol-forming substrate 104 is preferably maintained at a temperature below a vaporisation or aerosolisation temperature of an aerosol-forming material of the aerosol-forming substrate. In the boost heating mode, an increased level of heating is applied to the aerosol-forming substrate 104 relative to the maintenance heating mode, so as to increase the temperature of the aerosol-forming substrate to a temperature at or above the vaporisation or aerosolisation temperature.

FIG. 12 illustrates another exemplary scheme for supplying current to the inductor coil 24, 240. In the scheme shown in FIG. 12, the supply of AC current I_{AC} is switched on and off in successive phases, with the supply of DC current I_{DC} maintained over the successive phases. As for the scheme of FIG. 11, the phases preferably form part of a usage session of the aerosol-generating device 10, 150 in the consuming of the aerosol-forming substrate 104 of the aerosol-generating article 102, 172. The AC current I_{AC} and the DC current I_{DC} define respective first and second waveforms of electric power. The scheme of FIG. 12 may be implemented using the power circuitry of FIG. 9B. For the scheme of FIG. 12, the successive phases are i) where a puff is detected as being applied to the aerosol-generating article 102, 172, and ii) where no puff is detected as being applied to the aerosol-generating article. When no puff is detected as being applied to the aerosol-generating article 102, 172, only the DC current I_{DC} is supplied to the inductor coil 24, 240. However, upon determination by the controller 330 of a puff being applied to the aerosol-generating article 102, 172, the AC current I_{AC} is supplied to the inductor coil 24, 240 in addition to the DC current I_{DC} over the duration of the applied puff. The AC current I_{AC} has a frequency at or close to frequency f_{susceptor}, in which the AC current I_{AC} creates a varying magnetic field that best couples with the susceptor element 114, 164. As previously explained, the generation of AC current I_{AC} at or close to frequency f_{susceptor} allows the transfer of almost the totality of the energy in the flow of AC current I_{AC} through the inductor coil 24, 240 to the susceptor element 114, 164, resulting in heating of the susceptor element. In contrast, the flow of DC current I_{DC} through the inductor coil 24, 240 results in resistance heating of the inductor coil. So, when no puff is detected as being applied to the aerosol-generating article 102, 172, the aerosol-forming substrate 104 is solely heated externally by resistance heating of the inductor coil 24, 240 (due to the flow of DC current I_{DC}). However, when the controller 330 detects the application of a puff to the aerosol-generating article 102, 172, the aerosol-forming substrate 104 is heated both internally (through heating of the susceptor element 114, 164 in consequence of the AC current I_{AC}) and externally (through resistance heating of the inductor coil 24, 240 in consequence of the DC current I_{DC}). As for the scheme of FIG. 11, it will be appreciated that a change in amplitude of the AC current I_{AC} or DC current I_{DC} will result in a corresponding change in the level of heating arising from the respective current. It will also be appreciated that adjustment of the frequency of the AC current I_{AC} away from f_{susceptor} will reduce the level of heating of the susceptor 114, 164 in favour of increasing resistance heating of the inductor coil 24, 240. In a preferred embodiment, the application of DC current I_{DC} alone when no puff is applied may correspond to a “maintenance” heating mode, whereas the application of the combination of AC current I_{AC} and DC current I_{DC} over the duration of an applied puff may correspond to a “boost” heating mode. The boost and maintenance heating modes provide different levels of heating to the aerosol-forming substrate 104. In the maintenance heating mode, the aerosol-forming substrate 104 is preferably maintained at a temperature below a vaporisation or aerosolisation temperature of an aerosol-forming material of the aerosol-forming substrate. In the boost heating mode, an increased level of heating is applied to the aerosol-forming substrate 104 relative to the maintenance heating mode, so as to increase the temperature of the aerosol-forming substrate to a temperature at or above the vaporisation or aerosolisation temperature.

FIG. 13 illustrates another exemplary scheme for supplying current to the inductor coil 24, 240. In the scheme shown in FIG. 13, AC current I_{AC} is supplied to the inductor coil 24, 240 over first and second phases, with DC current I_{DC} only supplied in the second phase. As for the schemes of FIGS. 11 and 12, the phases preferably form part of a usage session of the aerosol-generating device 10, 150 in the consuming of the aerosol-forming substrate 104 of the aerosol-generating article 102, 172. The AC current I_{AC} and the DC current I_{DC} define respective first and second waveforms of electric power. The scheme of FIG. 13 may be implemented using the power circuitry of FIG. 9B. As shown in FIG. 13, the AC current I_{AC} is adjusted from a frequency f1 in the first phase to an increased frequency f2 in the second phase. This adjustment in frequency is achieved by increasing the frequency of the switching signal to the transistor switch 1326. Frequencies f1 and f2 provide differing levels of inductive coupling between the inductor coil 24, 240 and susceptor element 114, 164. Frequency f1 preferably corresponds to frequency f_{inductor coil}, in which the AC current I_{AC} creates a varying magnetic field that provides little or no coupling with the susceptor element 114, 164 and allows almost the totality of the energy of the AC current I_{AC} to remain within the inductor coil 24, 240, resulting in resistance heating of the inductor coil. Frequency f2 preferably corresponds to frequency f_{susceptor}, in which the AC current I_{AC} creates a varying magnetic field that best couples with the susceptor element 114, 164, so as to allow transfer of almost the totality of the energy from the AC current I_{AC} through the inductor coil 24, 240 to the susceptor element, resulting in heating of the susceptor element. As previously explained, the flow of DC current I_{DC} through the inductor coil 24, 240 results in resistance heating of the inductor coil. So, in the first phase of operation, the supply of AC current I_{AC} having frequency f1 (=f_{inductor coil}) results in resistance heating of the inductor coil 24, 240 in preference to heating of the susceptor element 114, 164. However, in the second phase of operation the supply of AC current I_{AC} having frequency f2 (=f_{susceptor}) results in heating of the susceptor 114, 164, with the supply of the DC current I_{DC} resulting in resistance heating of the inductor coil 24, 240. So, in the first phase, the aerosol-forming substrate 104 is solely or predominantly heated externally by resistance heating of the inductor coil 24, 240 (in consequence of AC current I_{AC} having frequency f1 (=f_{inductor coil})), whereas in the second phase the aerosol-forming substrate is heated both internally (through heating of the susceptor element in consequence of AC current I_{AC} having frequency f2 (=f_{susceptor})) and externally (through resistance heating of the inductor coil 24, 240 in consequence of the DC current I_{DC}). The first phase of operation corresponds to no puff being detected as applied to the aerosol-generating article 102, 172. The second phase of operation corresponds to the controller 330 having detected the application of a puff to the aerosol-generating article 102, 172. Again, it will be appreciated that a change in amplitude of the AC current I_{AC} or DC current I_{DC} will result in a corresponding change in the level of heating arising from the respective current. Preferably, the first phase in which no puff is applied corresponds to a “maintenance” heating mode and the second phase in which a puff is applied corresponds to a “boost” heating mode. In the maintenance heating mode (where no puff is applied), the aerosol-forming substrate 104 is preferably maintained at a temperature below a vaporisation or aerosolisation temperature of an aerosol-forming material of the aerosol-forming substrate. In the boost heating mode (where a puff is being applied), an increased level of heating is applied to the aerosol-forming substrate 104 relative to the maintenance heating mode, so as to increase the temperature of the aerosol-forming substrate to a temperature at or above the vaporisation or aerosolisation temperature.

FIG. 14 illustrates another exemplary scheme for supplying current to the inductor coil 24, 240. In the scheme shown in FIG. 14, a first AC current I_{AC1} having a first frequency f1 is supplied to the inductor coil 24, 240 over first and second phases, with a second AC current I_{AC2} having a second frequency f2 superposed with the first AC current LAC in the second phase. As for the schemes of FIGS. 11 to 13, the phases preferably form part of a usage session of the aerosol-generating device 10, 150 in the consuming of the aerosol-forming substrate 104 of the aerosol-generating article 102, 172. The first and second AC currents I_{AC1}, i_{AC2} define respective first and second waveforms of electric power. Frequencies f1 and f2 provide differing levels of inductive coupling between the inductor coil 24, 240 and susceptor element 114, 164. Frequency f1 preferably corresponds to frequency f_{inductor coil}, in which the first AC current I_{AC1} creates a varying magnetic field that provides little or no coupling with the susceptor element 114, 164 and allows almost the totality of the energy of the first AC current I_{AC} to remain within the inductor coil 24, 240, resulting in resistance heating of the inductor coil. Frequency f2 preferably corresponds to frequency f_{susceptor}, in which the second AC current I_{AC2} creates a varying magnetic field that best couples with the susceptor element 114, 164, so as to allow transfer of almost the totality of the energy from the second AC current I_{AC2} through the inductor coil 24, 240 to the susceptor element, resulting in heating of the susceptor element. So, in the first phase of operation, the supply of the first AC current I_{AC1} having frequency f1 (=f_{inductor coil}) results in resistance heating of the inductor coil 24, 240 in preference to heating of the susceptor element 114, 164. However, in the second phase of operation the introduction of the supply of the second AC current I_{AC2} having frequency f2 (=f_{susceptor}) results in heating of the susceptor 114, 164, with the continuing supply of the first AC current I_{AC1} maintaining resistance heating of the inductor coil 24, 240. The first phase of operation corresponds to no puff being detected as applied to the aerosol-generating article 102, 172. The second phase of operation corresponds to the controller 330 having detected the application of a puff to the aerosol-generating article 102, 172. Again, it will be appreciated that a change in amplitude of the first or second AC currents I_{AC1}, I_{AC2} will result in a corresponding change in the level of heating arising from the respective current. Preferably, the first phase in which no puff is applied corresponds to a “maintenance” heating mode and the second phase in which a puff is applied corresponds to a “boost” heating mode. In the maintenance heating mode (where no puff is applied), the aerosol-forming substrate 104 is preferably maintained at a temperature below a vaporisation or aerosolisation temperature of an aerosol-forming material of the aerosol-forming substrate. In the boost heating mode (where a puff is being applied), an increased level of heating is applied to the aerosol-forming substrate 104 relative to the maintenance heating mode, so as to increase the temperature of the aerosol-forming substrate to a temperature at or above the vaporisation or aerosolisation temperature.

FIG. 15 illustrates another exemplary scheme for supplying current to the inductor coil 24, 240. The scheme of FIG. 15 includes the first and second AC currents I_{AC1}, I_{AC2} having respective frequencies f1, f2 present in the scheme of FIG. 14, but additionally has a supply of direct current I_{DC} introduced to the inductor coil 24, 240 over the second phase. The supply of direct current I_{DC} over the second phase provides additional resistance heating of the inductor coil 24, 240. The first and second AC currents I_{AC1}, I_{AC2} and the DC current I_{DC} each define distinct waveforms of electric power.

FIG. 16 illustrates another exemplary scheme for supplying current to the inductor coil 24, 240. The scheme of FIG. 16 includes the first and second AC currents I_{AC1}, I_{AC2} having respective frequencies f1, f2 present in the scheme of FIG. 14, but additionally has a direct current I_{DC} supplied to the inductor coil 24, 240 over the both the first and second phases. The supply of direct current I_{DC} over the both of the first and second phases provides resistance heating of the inductor coil 24, 240. The first and second AC currents I_{AC1}, I_{AC2} and the DC current I_{DC} each define distinct waveforms of electric power.

Of course there are any number of possible schemes for supplying one or more AC currents and/or one or more DC currents to the inductor coil 24, 240 to provide a desired level of heating of the aerosol-forming substrate 104. It will also be understood that power circuitry differing from the configurations shown in FIGS. 9A and 9B may be employed; for example, having additional power sources and/or configured with an additional AC/DC power converter to that shown in the power circuitry of FIGS. 9A and 9B.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device, comprising:
a controller;
power circuitry configured to generate first and second waveforms of electric power that are independently controllable of each other, and
a heating assembly configured to heat a removable aerosol-forming substrate enclosing or containing a susceptor to generate an aerosol from the aerosol-forming substrate, the heating assembly comprising an inductor coil,
wherein the controller is configured to independently control application of the first and the second waveforms to the inductor coil separately or simultaneously with each other to generate heat through one or a combination of:
i) resistance heating by the inductor coil to externally heat the aerosol-forming substrate, and
ii) heating of the susceptor through inductive coupling of the inductor coil with the susceptor to internally heat the aerosol-forming substrate,
wherein the resistance heating by the inductor coil alone corresponds to a maintenance heating mode, in which the aerosol-forming substrate is maintained at a temperature below a vaporisation temperature of an aerosol-forming material of the aerosol-forming substrate,
wherein the heating of the susceptor through inductive coupling of the inductor coil with the susceptor alone or in combination with the resistance heating by the inductor coil corresponds to a boost heating mode, in which a temperature of the aerosol-forming substrate is increased to a temperature at or above the vaporisation temperature, and
wherein the controller is further configured to switch between the maintenance heating mode and the boost heating mode.

17. The aerosol-generating device according to claim 16, wherein the controller is further configured to switch from the maintenance heating mode to the boost heating mode in response to receiving a signal indicative of an applied puff.

18. The aerosol-generating device according to claim 16, wherein the power circuitry comprises a first current source and a second current source, the first current source and the second current source connected to the inductor coil and configured to apply two superposed currents as the first and the second waveforms, respectively, to the inductor coil.

19. The aerosol-generating device according to claim 16, wherein the power circuitry comprises a first voltage source and a second voltage source, the first voltage source and the second voltage source connected in series with each other and configured to apply two superposed voltages as the first and the second waveforms, respectively, to the inductor coil.

20. The aerosol-generating device according to claim 16, wherein the power circuitry comprises a single voltage source controllable to provide both the first and the second waveforms of electric power for application to the inductor coil.

21. The aerosol-generating device according to claim 16, wherein the controller is further configured such that the (i) resistance heating is performed by applying one or more of:
a) an alternating current or voltage as the first waveform of electric power to the inductor coil at a frequency to inhibit inductive coupling with the susceptor, and
b) a direct current or voltage as the first waveform of electric power to the inductor coil.

22. The aerosol-generating device according to claim 16, wherein the controller is further configured such that the (ii) heating of the susceptor is performed by applying an alternating current or voltage as the second waveform of electric power to the inductor coil at a frequency to promote inductive coupling with the susceptor.

23. The aerosol-generating device according to claim 16, wherein the controller is further configured to control application of the first and the second waveforms to the inductor coil to operate the heating assembly in each of:
a first heating mode in which a temperature inside a heating zone heated by the heating assembly is below a vaporisation or aerosolisation temperature of an aerosol-forming material of the aerosol-forming substrate, and
a second heating mode in which a temperature inside the heating zone heated by the heating assembly is at or above the vaporisation or aerosolisation temperature.

24. The aerosol-generating device according to claim 23, wherein the controller is further configured to control the application of the first and the second waveforms to the inductor coil to adjust a ratio of a power dissipated by resistance heating of the inductor coil to a power dissipated by heating of the susceptor through inductive coupling of the inductor coil with the susceptor from a first ratio for the first heating mode to a second ratio for the second heating mode.

25. The aerosol-generating device according to claim 23, wherein the controller is further configured to apply or adjust a frequency of an alternating current or voltage to the inductor coil when switching between the first and the second heating modes so as to change the inductive coupling of the inductor coil with the susceptor.

26. The aerosol-generating device according to claim 23, wherein the controller is further configured to simultaneously apply both an alternating current or voltage and a direct current or voltage to the inductor coil for one or both of the first and the second heating modes.

27. The aerosol-generating device according to claim 23, wherein the controller is further configured to:
apply an alternating current or voltage to the inductor coil for both of the first and the second heating modes, and
adjust a frequency of the alternating current or voltage applied to the inductor coil when switching between the first and the second heating modes so as to change the inductive coupling of the inductor coil with the susceptor.

28. The aerosol-generating device according to claim 23, wherein the controller is further configured to:
apply a direct current or voltage to the inductor coil for the first heating mode, and
on switching to the second heating mode, introduce an alternating current or voltage to the inductor coil, a frequency of the alternating current or voltage controlled such that all or a majority of thermal power dissipated by the heating assembly in response to the supply of alternating current or voltage arises from heating of the susceptor rather than from heating of the inductor coil.

29. A method of heating an aerosol-forming substrate to generate an aerosol therefrom, the method comprising:
providing a heating assembly comprising an inductor coil and a susceptor, the inductor coil positioned external to the aerosol-forming substrate, the susceptor enclosed within the aerosol-forming substrate, and the susceptor positioned at least partially within the inductor coil;
providing power circuitry configured to generate first and second waveforms of electric power that are independently controllable of each other;
independently controlling application of the first and the second waveforms to the inductor coil separately or simultaneously with each other to generate heat through one or a combination of:
i) resistance heating by the inductor coil to externally heat the aerosol-forming substrate, and
ii) heating of the susceptor through inductive coupling of the inductor coil with the susceptor to internally heat the aerosol-forming substrate,
wherein the resistance heating by the inductor coil alone corresponds to a maintenance heating mode, in which the aerosol-forming substrate is maintained at a temperature below a vaporisation temperature of an aerosol-forming material of the aerosol-forming substrate, and
wherein the heating of the susceptor through inductive coupling of the inductor coil with the susceptor alone or in combination with the resistance heating by the inductor coil corresponds to a boost heating mode, in which a temperature of the aerosol-forming substrate is increased to a temperature at or above the vaporisation temperature; and
switching between the maintenance heating mode and the boost heating mode.

30. The method according to claim 29, further comprising switching from the maintenance heating mode to the boost heating mode in response to receiving a signal indicative of an applied puff.
